(19) United States
(12) Patent Application Publication
(10) Pub. No.: US 2013/0297369 A1
(43) Pub. Date: Nov. 7, 2013

(54) Methodology and Preferred Software that, together, Reduce the Effort required to Write and Maintain Operating Procedures for Manufacturing Plants and Oil and Gas Facilities

(71) Applicant: KemeX Ltd., Calgary (CA)

(72) Inventor: David Shook, Edmonton (CA)

(21) Appl. No.: 13/660,060

(22) Filed: Oct. 25, 2012

Related U.S. Application Data
(60) Provisional application No. 61/551,101, filed on Oct. 25, 2011.

(51) Int. Cl. G06Q 10/06

(52) U.S. Cl. CPC G06Q 10/06316
USPC 705/7.26

(57) ABSTRACT

A method for generating and maintaining procedures for plant operation the method comprising:
a. Decomposing a plant into process units;
b. Decomposing each process unit into equipment modules (high-level objects);
c. Decomposing equipment modules into equipment units (low-level objects);
d. Defining operational states for equipment modules and equipment units;
e. Generating a procedures for changing operational states for equipment units;
f. Generating a procedures for changing operational states for equipment modules;
g. Encapsulating all the equipment units procedures and equipment modules procedures into process unit operations preferably in a computer database;
h. Providing feedback for presentation of the operational procedures and state changing operating procedures from the preferred database to an operator upon request;
i. Revising single equipment unit or equipment module operating procedure or state changing operating procedure upon request from the operator;
   wherein, the method allows the operator to receive a detailed description of an operating procedure for change of state of any process unit, equipment unit or equipment module in the plant from any state to any state.

### FIELD OF THE INVENTION

A methodology and software that, together, reduce the effort required to write and maintain operating procedures for manufacturing plants and oil and gas facilities. By doing so, it makes it possible for companies to have procedures that are more accurate, complete and up-to-date, and, in some cases, sufficiently detailed that they can be automated.

### BACKGROUND OF THE INVENTION

In industry, the operation of a plant has been codified by the creation of detailed procedures for all the possible operation situations. At present, this information is stored in a haphazard manner that prevents easy use of this information by other sources. Thus, one of the objectives of this method is to present a coherent and logical classification of all the available data by efficiently documenting the procedures and by defining the procedures in terms of an equipment hierarchy consistent with the ISA-S88 standard, a design philosophy for the description of equipment and operation procedures. It is expected that this design philosophy can lead to automation using a standard distributed control system (DCS) that has already been widely implemented in manufacturing industry.

One approach to improving the writing of procedures is to apply the ideas of object-oriented software design to the codified operating procedures. In this approach, a procedure can be defined as a sequence of instructions, that is a program, executed by operators to bring a unit from an initial mode (state) to a final mode (state). The state of a unit can be defined as an operating mode with any associated faults. Unfortunately, one drawback with using an object-oriented approach to procedure automation is that there is an overlap of terminology with different meanings. However, the user interface should use the industrial terminology. The following analogues can be drawn between the object-oriented software approach and the concepts of procedure automation:
Equipment types are analogous to classes in object-oriented programming. Thus, procedures defined on a given equipment type are analogous to methods.
The plant can be decomposed hierarchically using the ISA-S88 methodology. This hierarchical decomposition gives a reasonable amount of complexity at any level of detail.
Equipment items are analogous to instances of a class in object-oriented programming.
Any given equipment item is only aware of its immediate children, parent, and siblings, that is, encapsulation.
Different, but similar, equipment items/types inherit from the same base class. Differences can be accounted for by subclasses or using the Decoration pattern.
For a given piece of equipment, there is a reasonable number of operating modes. These modes define the states for the state transition diagram.
Each permitted transition from one mode to another requires at least one procedure; additional procedures will normally be emergency ones.
Each system can be in one of several conditions dependent on its functionality.
Faults are subsets of conditions, and are defined as unintended or undesired behaviour of a system. A given fault is only relevant for some modes. When a fault occurs, it will have an effect on the mode of the equipment item in which it occurred. This fault will propagate up (and probably down) the hierarchy and will require the operator to initiate at least one new procedure. The exact procedure to initiate this has not yet been determined.
Each condition requires a procedure to detect it and another to mitigate it.
Procedures are more effectively communicated with drawings than with many pages of text. Drawings are lower in information density, but they permit comparisons across the plant, and show simultaneous actions and conditions more clearly.

### PRIOR ART

1. Honeywell has done a considerable amount of work on the automation of procedures: http://hpsweb.honeywell.com/Cultures/enUS/Products/OperationsApplications/OperationsManag ement/ProceduralOperations/default.htm and various pages referred to by that page.
2. Emerson has been active as well, especially in the batch industries http://www.emersonprocess.com/home/library/articles/pharmengr/pharmengr0411_maderia.pdf.
Batch control standard, in particular Part1 (http://en.wikipedia.org/wiki/ANSI/ISA-88.
4. ANSI/ISA 95 Standard on Enterprise-Control System Integration, in particular Part 1 page 23 (attached).
5. Technical report in draft, being assembled by ISA 106 committee (of which I have become a member as of early 2011).
   Document is in draft and not yet publicly issued, but contains insight into work done elsewhere.
6. NovaTech Paperless Procedures.

Many of these steps have been used in the automation of batch plants, but have not been applied to continuous processing plants. Batch plants operate in a manner similar to a kitchen: everything starts clean and put away, a recipe is executed, and everything ends up clean and put away. Pharmaceuticals and food processing are typically batch processes. In contrast, in the oil and gas, refining and petrochemical industries (among others), the plant runs continuously for a year or longer, in spite of different pieces of equipment starting and stopping along the way.

It is therefore a primary object of the invention to provide a method of generating operating procedures for singular and multiple levels of continuous plant operations by utilizing a hierarchical approach to decomposing and subsequently encapsulating operations for a given operation(s).

Further and other objects of the invention will become apparent to one skilled in the art when reviewing the summary of invention and the more detailed description of the preferred embodiment described and illustrated herein.

### SUMMARY OF THE INVENTION

A method and software is provided that together, reduce the effort required to write and maintain operating procedures for manufacturing plants and oil and gas facilities. By doing so, it makes it possible for companies to have procedures that are more accurate, complete and up-to-date, and, in some cases, sufficiently detailed that they can be automated.

It considers procedures not as documents, but as software that is executed by humans, not computers. It uses the techniques of object-oriented software design and development to manage the process of defining the procedures that are required, and minimize the writing and re-writing of operating procedures.

The key idea here is to take tools and methods that have been applied to automation and computer programming, and use them in the generation of documents intended for a human audience, not a computer. Ultimately, the documents so created will be an excellent starting point for automation, which is preferred but the automation per se is not essential.

Description of the Method:

At its core, the method pertains to writing operating procedures for equipment using a number of techniques to minimize rework. These techniques result from the adaptation of object-oriented software development techniques to the writing of operating procedures: considering procedures to be software executed by people or automation systems, not text documents.

| Object-Oriented Software | |
|---|---|
| Development Term | Process Industry Procedure Term |
| Object | Equipment Item |
| Class | Equipment Type |
| Attribute | Attribute |
| Method | Procedure |
| Function call | Subprocedure |

The techniques used are:
1. Decompose the plant into an equipment hierarchy. In the continuous process industries, plants are normally divided into areas and units. This merely continues that subdivision into subsystems within a unit, and possibly sub-subsystems, eventually reaching the final, individual items that are acted on by an operator or control system—valves, motors, sensors, etc.

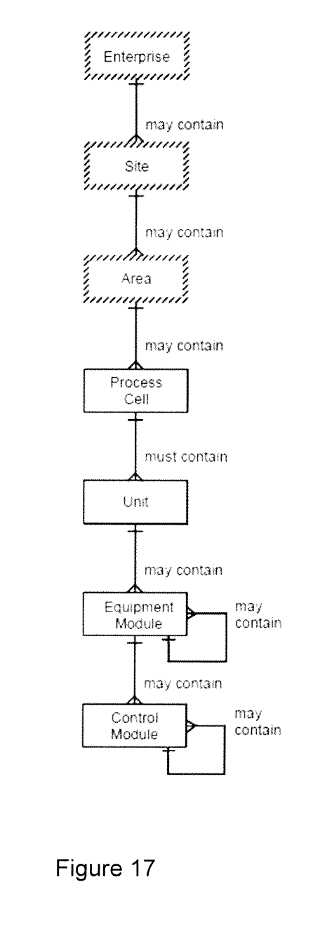

This hierarchical decomposition is a standard approach for batch control, in which case there is a well-defined terminology and reasonably well-defined methodology. For more details, see ANSI/ISA 88.01-1995, in particular Section 4.2, Physical Model. It is also used in ANSI/ISA 95.00.01-2000, see Section 5.2, Equipment Hierarchy Model, and it can be traced back at least as far as the Purdue Reference Model for CIM (1989). See FIGS. 17, 18 and 19

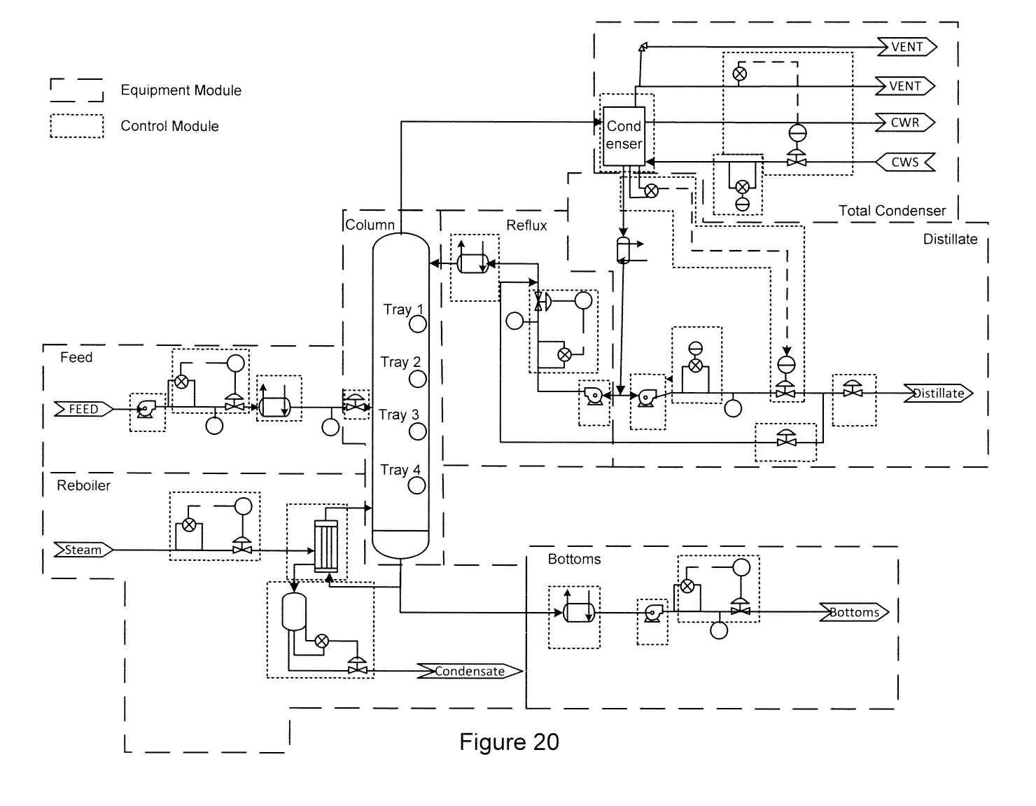

In the case of the new method, the equipment hierarchy is used to define relationships between larger-scale items (systems) and smaller-scale items (components). As will be clarified below, the procedures for larger systems largely consist of activities carried out on components. The use of a hierarchy allows a procedure to be defined at a high level with a certain amount of abstraction, leaving low-level execution details to the lower-level components. See FIG. 20

Unlike other approaches, the new method does not consider the hierarchy to be one of strict containment, but one of association. In other words, a lower-level component may be part of one or more higher-level systems. This is important in the process industry for components such as heat exchangers and flow controllers at the boundaries between two units. In such cases, a strict hierarchy enforces tedious workarounds. In an object-oriented approach, where objects interact through association and references, no strict hierarchy is required.

In the distillation column example, the distillation column is the unit, and it is made up of seven component Equipment Modules: Feed, Column, Total Condenser, Reflux, Reboiler, Distillate and Bottoms. Each Equipment Module is composed of a number of Control Modules.
2. Write each procedure for a type of equipment (equipment type), rather than actual equipment items. This is analogous to defining object classes with methods defined for the class.

For example, standard operating procedures (SOP's) are often written for common subsystems. There are standard ways to isolate a pump, drain a tank, etc. and these procedures are part of any plant's operating manual and training system. These SOP's are an example of a procedure that is written for a type of equipment, rather than a specific item.

By adopting a disciplined methodology, similar equipment items can be identified across the plant, at different levels of the hierarchy. In the distillation column example, it is clear that items such as control valves and heat exchangers are used throughout the unit. There should therefore be SOP's for these items. Moving up one level in the hierarchy, the Feed and Bottoms Equipment Modules can be seen to be very similar. Each has a pump, a flow controller and a heat exchanger. The two modules can have a common set of procedures. As long as the two Equipment Modules have the same Equipment Type, and procedures are written for that Equipment Type, then only one set of procedures needs to be written, and, more importantly, kept updated.
3. There are similar, but slightly different, configurations of equipment throughout the plant. (Class Hierarchy)

By using the notion of an “object hierarchy” or “equipment type hierarchy”, equipment types can be grouped, and commonalities can be found among similar equipment types. Then, if some of the equipment types share common procedures, those procedures can be shared automatically.

For example, the Reflux Equipment Module is very similar to the Feed and Bottoms Equipment Modules. It also has a heat exchanger, flow controller and pump. The Distillate Module is similar, but has an additional level controller and bypass valve. Some of the procedures for these two Equipment Modules may be identical to those for the Feed and Bottoms. The method for determining the degree of similarity will be discussed below. At the moment, it should be sufficient to indicate that Feed and Bottoms are of one Type, and that Reflux and Distillate are similar, with some differences. It is possible to define an Equipment Type Hierarchy, where the more complex Equipment Types are derived from the simpler ones. Each procedure for a more complex Equipment Type can then be defined as specific to that derived type, or just use the procedure defined for the more basic Equipment Type (Base Class).
4. At any given level of the plant, the equipment or process has a manageable number of mutually-exclusive ways of behaving—modes.

This one is a bit complicated. There are both control theory and psychological reasons why this item is true.

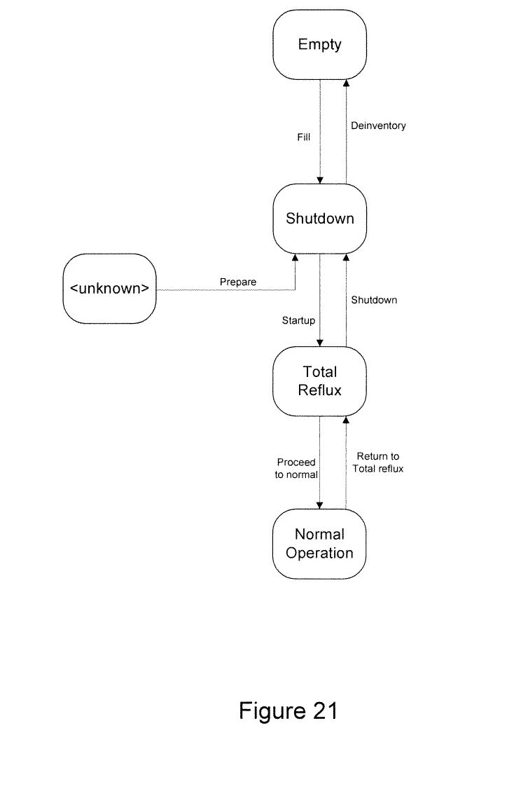

To consider a simple example, an automatic transmission may be in park, reverse, neutral or drive. In each of these modes, the transmission behaves differently. Similarly, process equipment can have modes, and, it turns out, so can the process itself. The field of hybrid control is concerned with modeling and controlling systems that change operating mode. One way of thinking about operating modes is that the equations that govern the behavior of the system change when an equipment item or process changes modes. For an automatic transmission there are profound differences in behavior between Reverse and Drive. Similarly, a distillation column changes behavior profoundly between Empty, Shutdown, Total Recycle and Normal operation.
5. It is possible to list the physically possible and practical transitions between different modes. Each transition requires a procedure. See FIG. 21.

The FIG. 21 shows the different modes for the distillation column, and the different transitions that can happen among those modes.

Each transition is a procedure that must be defined.
6. There is a relationship between the modes of a higher-level system and lower-level components. This relationship typically extends only one hierarchy level up or down.

| Distillation | | | | |
|---|---|---|---|---|
| Column | Shutdown | Normal | Total Reflux | Empty |
| Feed | Shutdown | Normal | Shutdown | Isolated |
| Column | Shutdown | Normal | Normal | Empty |
| Condenser | Shutdown | Normal | Normal | Empty |
| Reflux | Shutdown | Normal | Normal | Empty |
| Reboiler | Shutdown | Normal | Normal | Isolated |
| Distillate | Shutdown | Normal | Shutdown | Isolated |
| Bottoms | Shutdown | Normal | Shutdown | Isolated |

Valid Component Modes for Each System Mode

In the case of the distillation column, for each mode for the column, there is a simple set of valid modes for the subsystems.

There are three consequences for this relationship:
Any time a component is in a different mode than indicated in the table, that indicates a fault condition that needs to be resolved. This is a way of identifying mis-operation. An automated system can be developed that detects the mode of each equipment item in the plant, and then highlights any systems where components are not in appropriate modes.
One of the issues with hybrid control theory in general is that as the number of equipment items increases, the permutations of modes proliferate amazingly quickly, This approach allows a finite, manageable number of valid modes to be defined.
The initial and final conditions for distillation column procedures can be defined in terms of modes (and procedures) of the components. For example, for the distillation column to go from Shutdown to Total Reflux, the “startup” procedure, all of the equipment modules need to start in “Shutdown”. By the end of the startup procedure, the Column, Condenser, Reflux and Reboiler will need to be in Normal mode, while the Feed, Distillate and Bottoms will be Shutdown. The component Equipment Modules may pass through other modes along the way, but the initial and final conditions are defined, and can be checked and verified, both when writing the operating procedure and when executing it.

This third consequence is of major significance, and is an innovation. Taking it a step further, the procedure for each Equipment Module will be defined in terms of the contained Modules and their modes. If there were additional layers in the hierarchy, the procedures for each layer would be defined in terms of the operating modes of the equipment one layer down. As a result, the operating procedure, as defined at any level of the equipment hierarchy, has a manageable complexity. Thus, any changes to a procedure are restricted to the level of the plant that changes. This vastly simplifies the individual procedures, and the change management is correspondingly simplified.
7. There are many different things that can go wrong within a given operating mode. A pump may be leaking or vibrating, a heat exchanger may be fouled or leaking from the tubes or the shell, etc. Similarly, there may be faults with the operation of the process. The distillation column may be flooding; the distillate product may be off-specification, etc.

Each of these is called a condition. Each condition requires an inspection procedure to determine if it is happening, and a mitigation procedure in response. Unlike modes, conditions are not mutually exclusive. For example, a pump might be both vibrating and leaking. Just as with modes, though, conditions and their procedures are defined for Equipment Types.

The current mode and set of active conditions together define the state of an Equipment Item. Not every condition can happen for every mode. For each condition there is a set of valid modes, where the condition may occur. This is an extension of the concept of Dynamic Alarming or Logical Alarming, as defined in ISA 18.02—Management of Alarm Systems for the Process Industries. In the ISA standard, Dynamic Alarming is defined, but implementation is not addressed. The new method provides a way to define and manage dynamic alarms in accordance with ISA 18.02.
8. Different equipment items of the same type may have different requirements. For example, one pump may be pumping potable water at 25 degrees C. and 100 kPa. Another, essentially identical, pump may be pumping 50% caustic at 80 degrees and 1000 kPA. These two pumps would require quite different treatment from a safety point of view. Similarly, a large, high-speed pump may need to be started up more slowly than a small, slow pump. For this reason, equipment may have attributes, variables containing information that is relevant to the procedures. As with everything else, attributes are defined for Equipment Types. Attribute values are determines for each specific Equipment Item. Some obvious Attributes that apply to every Equipment Item are: minimum and maximum temperature, minimum and maximum pressure, and process material contained within the equipment. Other static information such as Manufacturer, materials of construction, model number, etc may be defined as well, and can be particularly useful for lookup of reference information.
9. Procedures may also have parameters, variables that take on different values, depending on the specific use of the procedure or attribute value of the equipment. For example, while initially inventorying the distillation column before startup, the Feed module will run at a specific fixed flow rate. When running under normal operating conditions, the Feed module will run at a different flow rate. The target flow rate is a parameter of the procedure.

According to a primary aspect of the invention there is provided the following method:
The plant(s) are decomposed into a hierarchy according to an industry standard: the ANSI/ISA 88 physical model. ANSI/ISA 88 is an industrial standard for batch control. Needless to say, the use of the ANSI/ISA 88 physical model is not an innovation. It is a necessary precursor.
2. The plant is analyzed to find similar or identical processes and equipment in different locations, and at different levels in the hierarchy. These similar/identical items are “instances” of “object classes” (or “objects”), and the types of item are “classes”. There is a meaningful hierarchy of object types, or classes, in that all pumps are a type of rotating equipment, all centrifugal pumps are pumps, all downhole pumps are centrifugal pumps, etc. This “class hierarchy” becomes useful later.
3. The operating modes (on/off, normal/recycle/shutdown, etc.) that exist at different levels in the plant hierarchy are identified by class. Modes are mutually exclusive: an object is in one mode at a time, or is transitioning from one mode to another.
4. The different conditions that may exist are identified by class. Conditions are usually faults, such as “leaking”, “vibrating” etc.
5. Each condition may only be applicable for certain modes. For example, a pump must be running in order to be vibrating, but it may be leaking whether it is running or not.

These “applicable modes” are determined for all conditions. In the field of alarm management, it has been recognized that (a) alarms should indicate fault conditions and (b) alarms may only be relevant under certain operating modes. The more precise language and methodology used here has not, to my knowledge, been applied before.
6. The relationships between modes of related equipment are defined. For example, for a car, in order to be legally parked, the engine must be off. If the engine is on, and the car is stationary, then the car is idling. In this case, the mode of the engine (on or off) helps determine the mode of the car. In this way, the mode of lower level objects (engine) affects the mode of higher level objects (car). To continue the example of a car, if the engine is running, the transmission is in gear, and the wheels are turning then the car can be considered to be in motion. If the parking brake is on while the car is in motion, then this is a mistake. The formalism allows these mistakes to be defined simply, by defining the set of correct lower-level object modes for a higher-level object. All other lower-level object modes are incorrect and would require an operator response. Once defined, these incorrect modes may be detected automatically.
7. The procedures that must exist are identified, by determining the transitions that must happen between states. Each transition requires a procedure. Each condition requires at least two: one to detect it and another to mitigate it. Additional procedures may be required for transitions that occur from one state back to the same state. In the car example, a procedure for overtaking returns the car to its original state (in motion at the speed limit). Similar types of procedure exist in the process industries.
8. Procedures are determined, and written, in terms of equipment types, not specific equipment items (all tanks require a procedure to drain them, so it may be a single procedure, not one per tank). Then, they are applied to specific equipment to create the specific procedure for that equipment. This requires the definition of “attributes” —values that vary from one equipment item to another within a class: pump capacity, number of gears in a transmission, fuel type, etc.
9. Moreover, procedures at a high level in the hierarchy do not need to contain the details at a lower level. Instead, high-level procedures only need to know what transition is required at the lower level. As an example, to start driving a car, you get in, put on your seatbelt, turn on the engine, release the parking brake, put the car into gear etc. How each of these individual steps is carried out depends on the individual car, but it is sufficient to define the high level procedure, and leave the low level details to the low level component: how to release the parking brake depends on the details of the brake system. At the highest level, you only need to know that it needs to be released. This principle of delegating details to other items is well-known in batch control (ANSI/ISA 88 mentioned above).
10. As procedures are defined, the set of modes for each class of object becomes more clearly procedure where each step changes the mode of a piece of equipment, it is easy to verify that the equipment was already in the right mode for the transition to occur, and if not, to flag that as a possible error.
11. The procedures are defined using flowcharts that allow steps to be defined as happening in sequence, potentially happening in parallel, and explicitly showing decisions, loops, and most importantly, references to sub-procedures. These sub-procedures are the transitions for lower-level objects that are defined for those lower-level classes.
12. When a procedure is defined for a specific action, it may have “parameters”, such as required temperature, that are specific to that case. There may be a relationship between that parameter and attributes of the equipment, such as maximum temperature, that can be checked within the procedure. This checking can be automated within the procedure definition system as long as the equipment attributes are defined and the correct values are assigned.
13. The graphically-defined procedure can be converted directly and automatically to a structured text document.
14. The structured text document can be navigated to show or conceal levels of detail, so junior operators can have all steps shown, while more experienced operators can expose only the higher level steps.
15. Following the definition of procedures, at regular intervals and following operating incidents, procedures need to be revised. This system allows the procedures to be changed at the most generic level possible, and also shows the number of locations that must be updated, since the changes are made for the class, not the object.
16. For truly unique equipment, or when a user is not familiar with the tools, it is possible to define procedures specifically for an equipment item directly by copying the procedure from the object definition. This loses the efficiencies that accrue from defining procedures for the class, but does allow some flexibility and efficiency for unique equipment.
17. It is also possible to “refactor” or tidy up the object hierarchy and procedure set at intervals. The final procedure documents can be automatically compared to the originals to ensure that no functional changes have occurred.
18. Because the number of transitions is known, the number of procedures that must be written is known as well. It is therefore possible to gauge and document the completeness and readiness of the procedure set against an objective measure. This simplifies and improves management reporting and compliance.
19. A certain amount of iteration occurs. This uncovers assumptions, inconsistencies and errors in the original thought process and allows the procedures to be more accurate. For example, in a written procedure it is easy to get steps out of order or to miss a step.

According to a primary aspect of the invention there is provided a method for generating and maintaining procedures for plant operation the method comprising:
a. Decomposing a plant into process units;
b. Decomposing each process unit into equipment modules (high-level objects)
c. Decomposing equipment modules into subordinate equipment modules (low-level objects);
d. Defining operational states for equipment modules and equipment units;
e. Generating a procedures for changing operational states for equipment units;
f. Generating a procedures for changing operational states for equipment modules;
g. Encapsulating all the equipment units procedures and equipment modules procedures into process unit operations preferably in a computer database;
h. Providing feedback for presentation of the operational procedures and state changing operating procedures from the preferred database to an operator upon request;
i. Revising single equipment unit or equipment module operating procedure or state changing operating procedure upon request from the operator;
   wherein, the method allows the operator to receive a detailed description of an operating procedure for change of state of any process unit, equipment unit or equipment module in the plant from any state to any state.

In one embodiment the same operating procedure for an equipment module can be reused for another equipment module.

Preferably the same state changing operating procedure for an equipment unit can be reused for another equipment unit.

In another embodiment one operating procedure may be used in several instances for operation of several equipment modules, while upon revising this procedure, it will be automatically revised for all the instances in all the processes, thus reducing the need to edit numerous instances of operational procedures.

Preferably one state changing operating procedure may be used in several instances for operation of several equipment units, while upon revising this procedure, it will be automatically revised for all the instances in all the processes, thus reducing the need to edit numerous instances of operational procedures.

Preferably the method of generating and maintaining procedures for plant operation can be adapted to be used in another plant with similar set of plant units without rewriting the whole operational procedure.

Preferably the method, wherein the procedure can be adapted to be used in another plant with different set of plant units without rewriting the whole operational procedure.

According to yet another aspect of the invention there is provided a method for providing SAGD plant operation procedures, the method comprising:
Decomposing an SAGD plant into process units such as: water de-oiling unit, evaporator unit, inlet cooling and separation unit etc.;
Decomposing each process unit for example evaporator unit into equipment modules such as: feed module, distillate tank, evaporating tower, compressor, etc;
Decomposing equipment modules for example compressor into subordinate equipment modules such as first centrifugal pump, second centrifugal pump, suction drum, motor etc.;
Defining operational states for equipment modules and equipment units for example: shut down, normal operation, recycling mode, heating mode, cooling mode, bypass etc;
Generating a procedure for changing operational state for equipment units for example: in order to change state of evaporator tower from normal to internal recycling operation, a specific set of steps has to be followed;
Generating a procedure for changing operational state for equipment modules for example: in order to change centrifugal pump from full off to normal operation a specific set of steps has to be followed;
Encapsulating all the equipment unit procedures and equipment module procedures into process unit operations preferably in a computer database for example: in order to operate an evaporator unit the following modules have to be initiated: feed module, tower module, compressor module and distillate module while each module in turn has the sets of operation for each of its corresponding units incorporated as well;
Providing feedback for presentation of the operational procedures and state changing operating procedures from the preferred database to an operator upon request for example: if the operator wishes to switch the evaporator from normal operation to internal recycle, the system will provide a detailed set of steps and the instructions of how to follow those steps;
Revising single equipment unit or equipment module operating procedure or state changing operating procedure upon request from the operator, if during the operation it was found that one of the instructions should be corrected, the correction can be made in the procedure of a specific equipment module or unit;
   wherein, the method allows the operator to receive a detailed description of an operating procedure for change of state of any process unit, equipment unit or equipment module in the plant from any state to any state.

In one embodiment the same operating procedure for an equipment module can be reused for another equipment module.

Preferably the same state changing operating procedure for an equipment unit can be reused for another equipment unit.

In another embodiment one operating procedure may be used in several instances for operation of several equipment modules, while upon revising this procedure, it will be automatically revised for all the instances in all the processes, thus reducing the need to edit numerous instances of operational procedures.

In another embodiment one state changing operating procedure may be used in several instances for operation of several equipment units, while upon revising this procedure, it will be automatically revised for all the instances in all the processes, thus reducing the need to edit numerous instances of operational procedures.

Preferably the procedure can be adapted to be used in another plant with similar set of plant units without rewriting the whole operational procedure.

In another embodiment, the procedure can be adapted to be used in another plant with different set of plant units without rewriting the whole operational procedure.

### BRIEF DESCRIPTION OF THE PREFERRED EMBODIMENTS

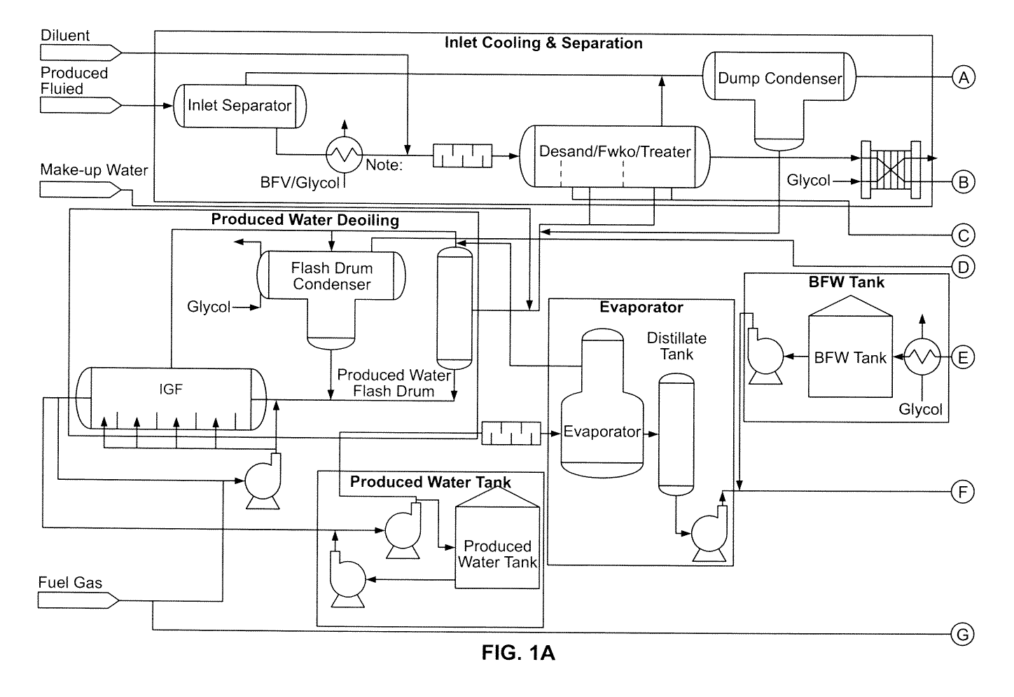

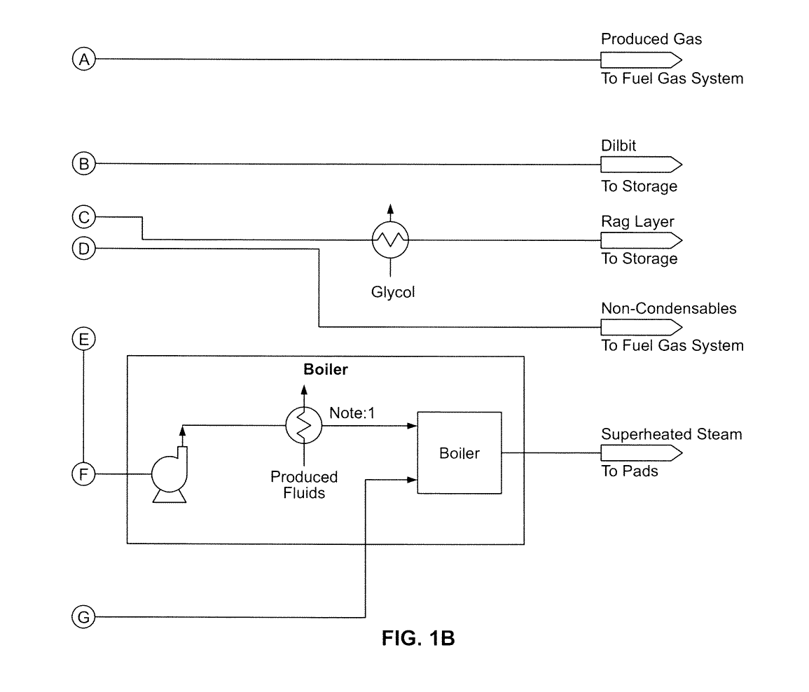

FIGS. 1A and 1B illustrate a schematic decomposition of a plant into process units.

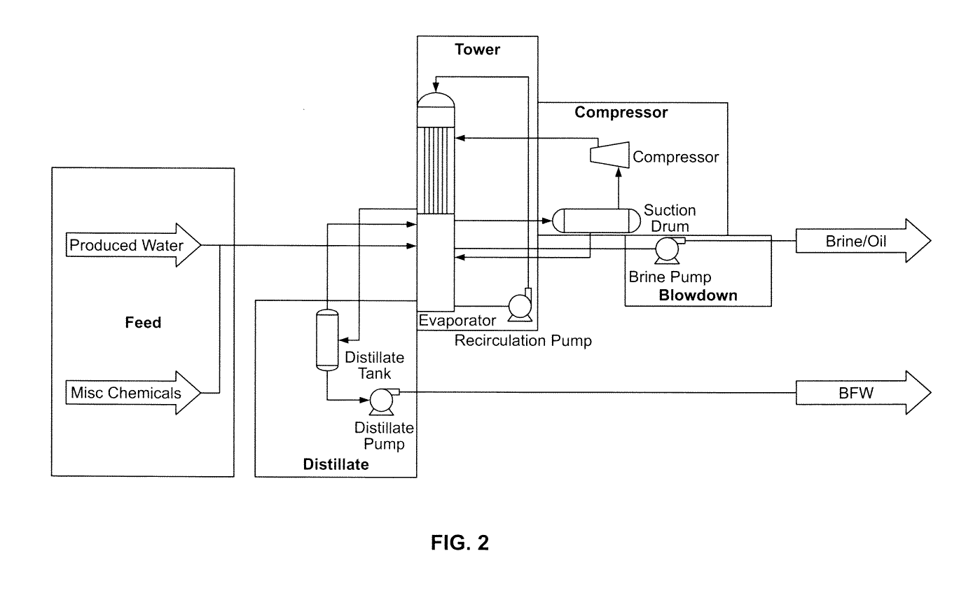

FIG. 2 illustrates a schematic decomposition of an evaporator process unit into process equipment modules.

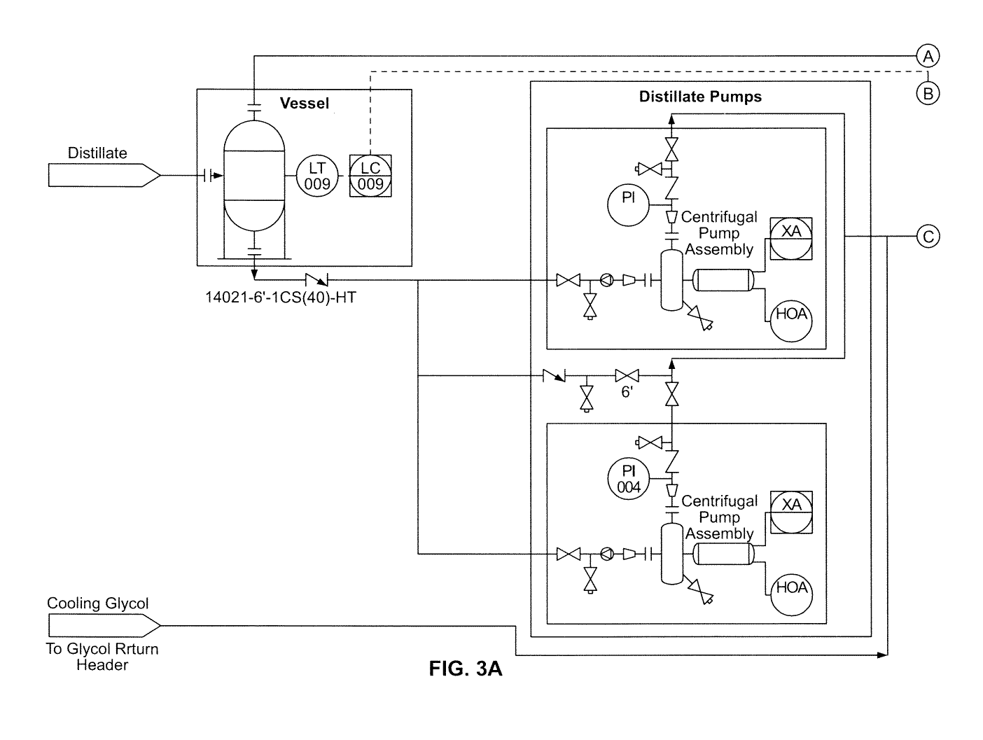

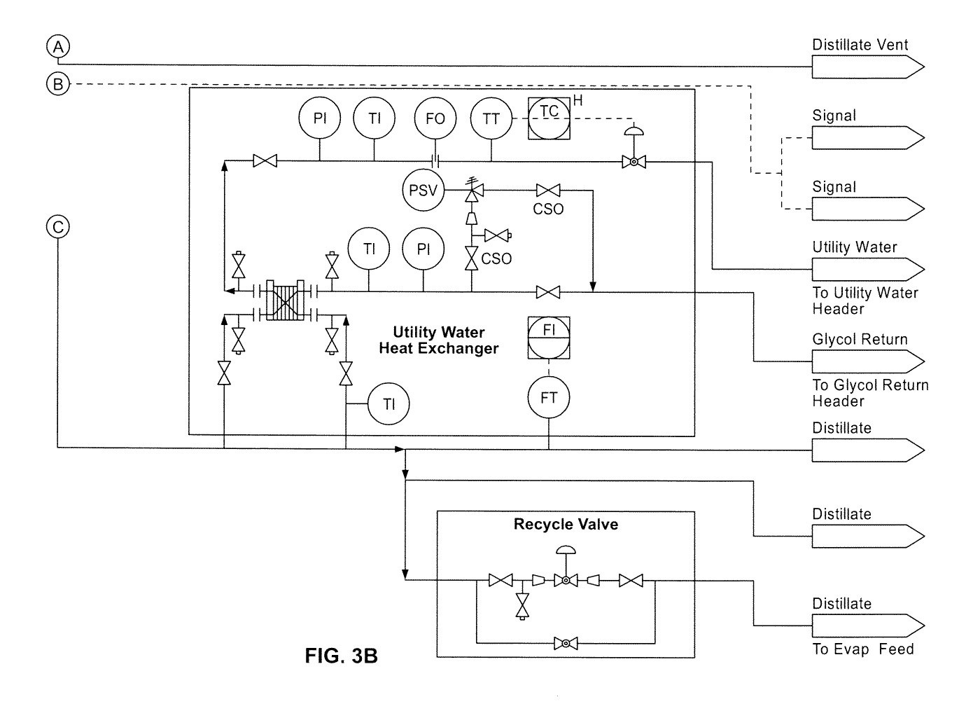

FIGS. 3A and 3B illustrate a schematic decomposition of the Distillate equipment module into low level equipment modules.

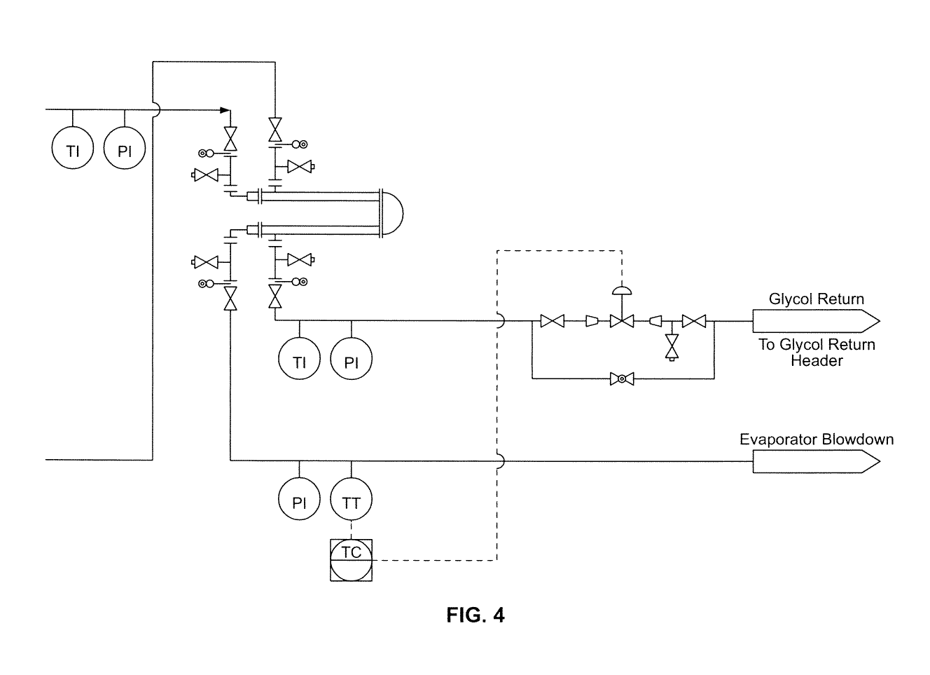

FIG. 4 illustrates low level equipment modules.

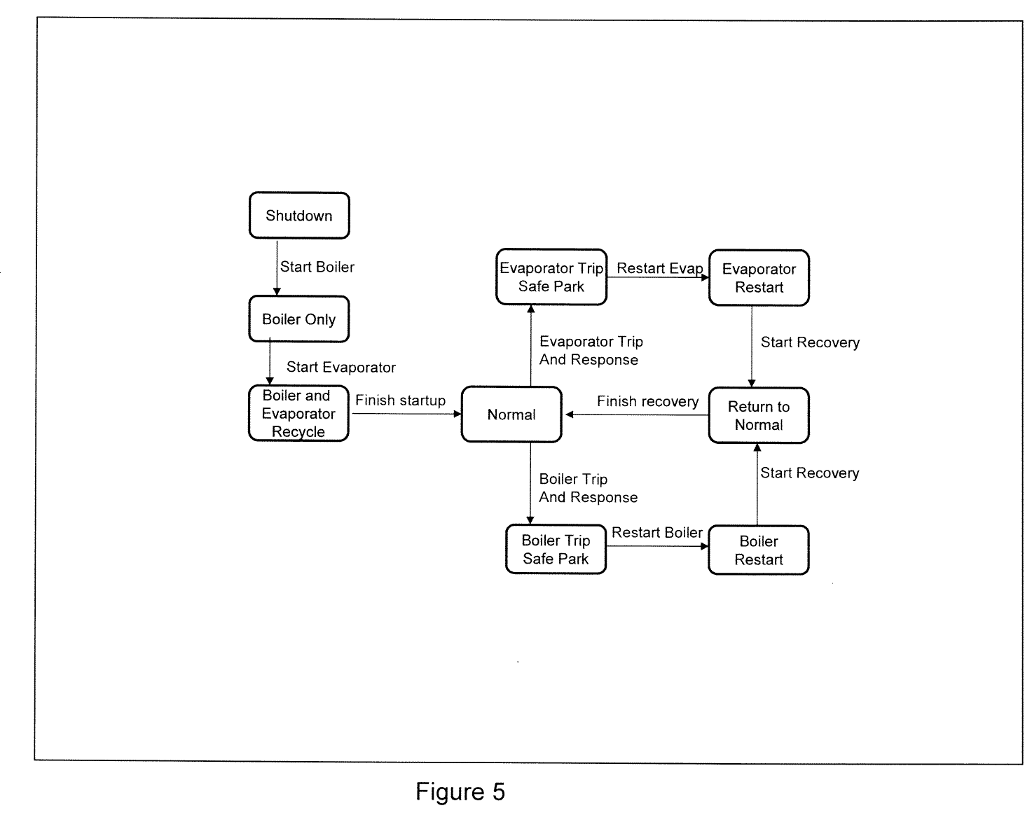

FIG. 5 illustrates an operational modes and state chart at a plant level.

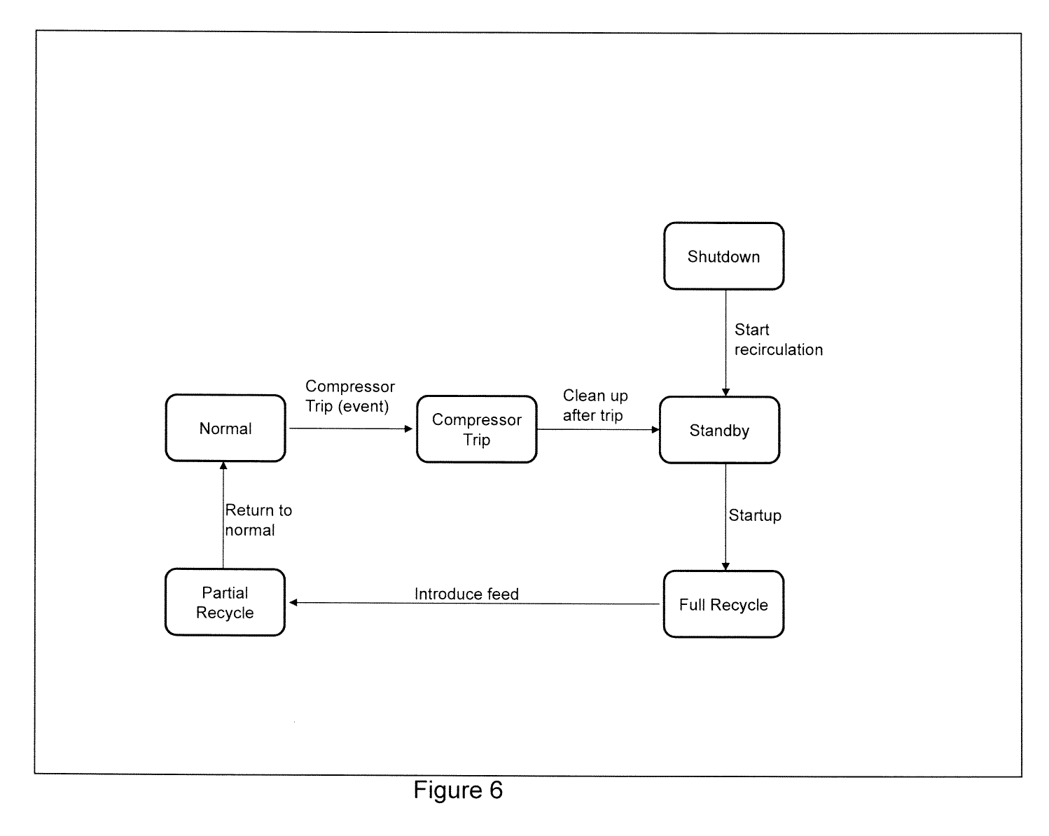

FIG. 6 illustrates an operational modes and state chart at unit level (Evaporator).

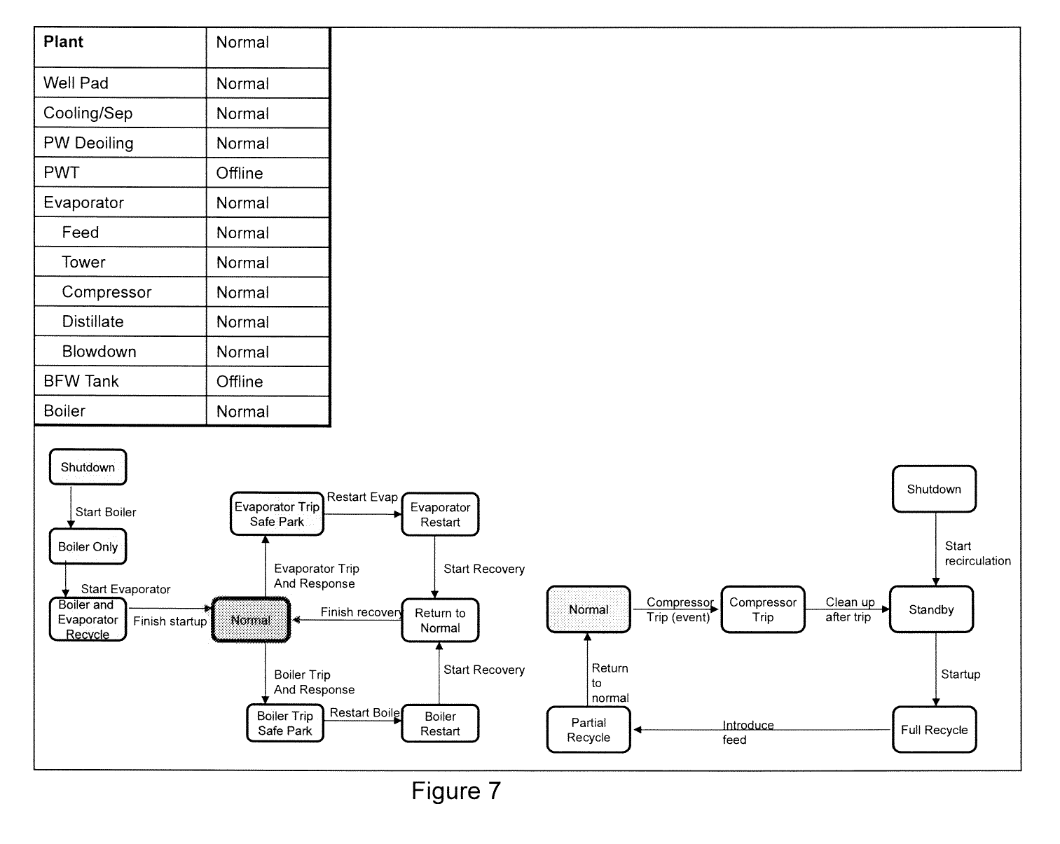

FIG. 7 illustrates a normal operation state of the plant and evaporator unit.

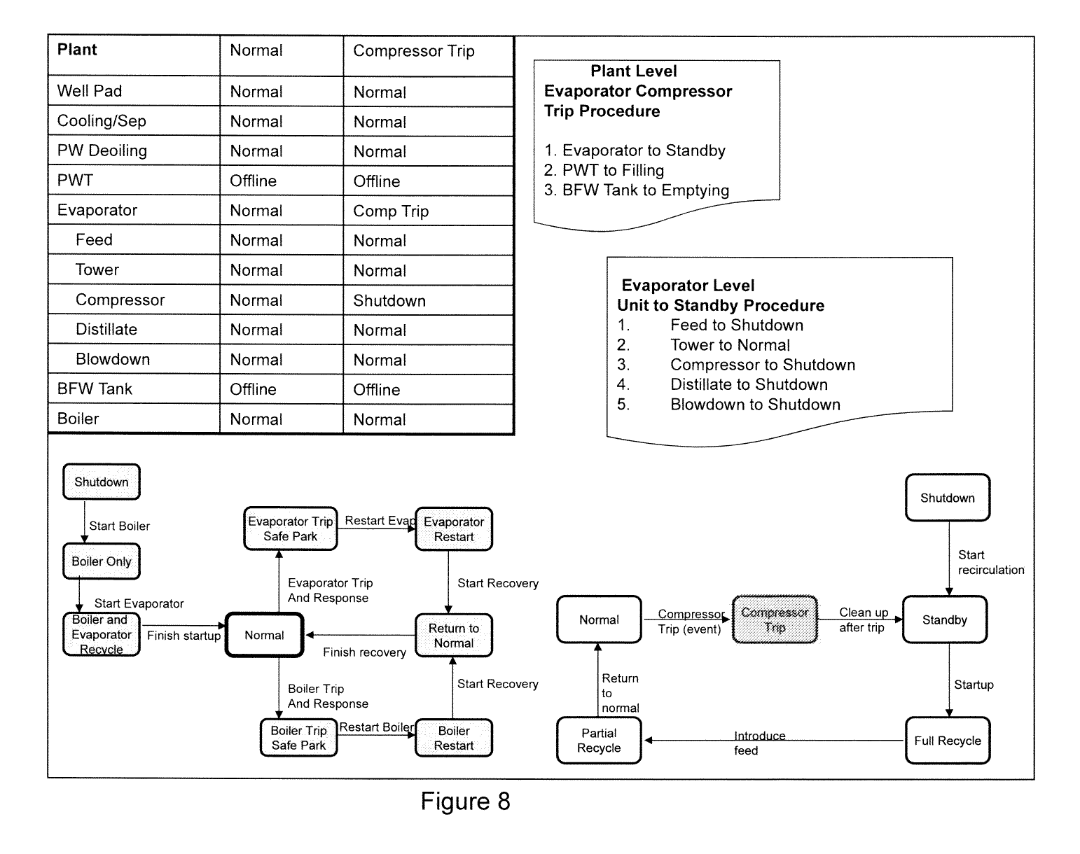

FIG. 8 illustrates a malfunction state of plant and evaporator unit.

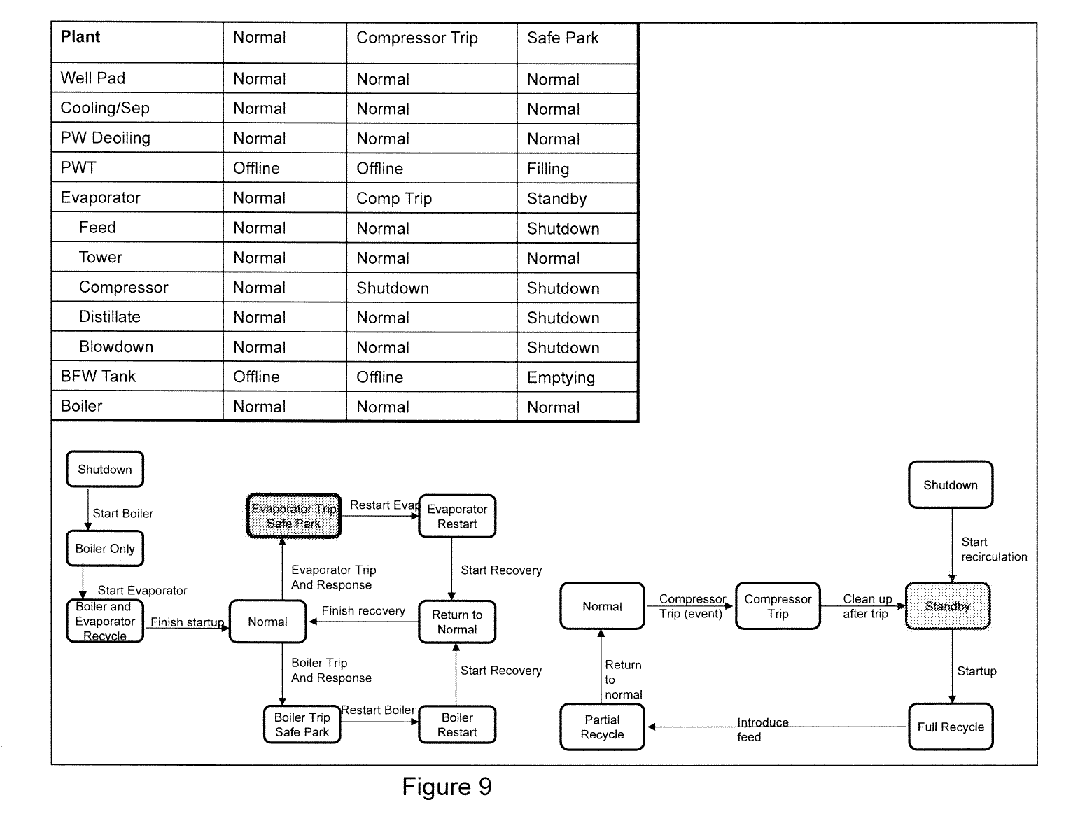

FIG. 9 illustrates steps for a mode change as a response to the malfunction.

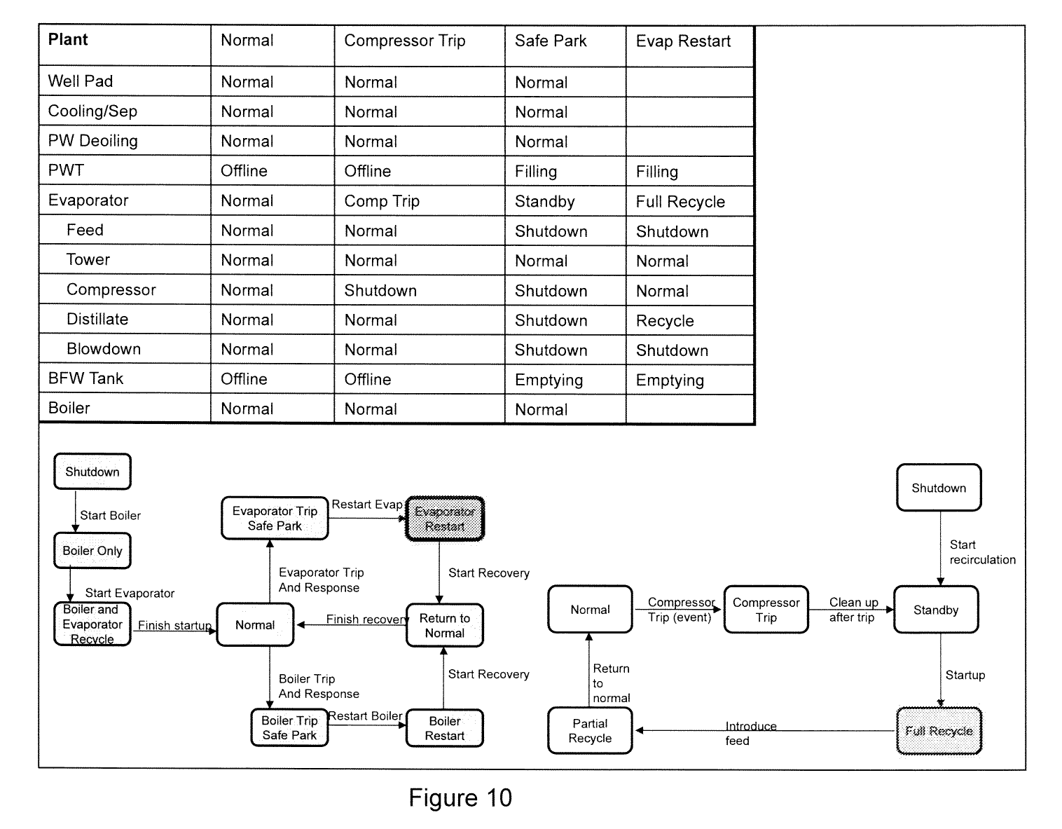

FIG. 10 illustrates steps for a mode change to return to normal operation while restarting evaporator.

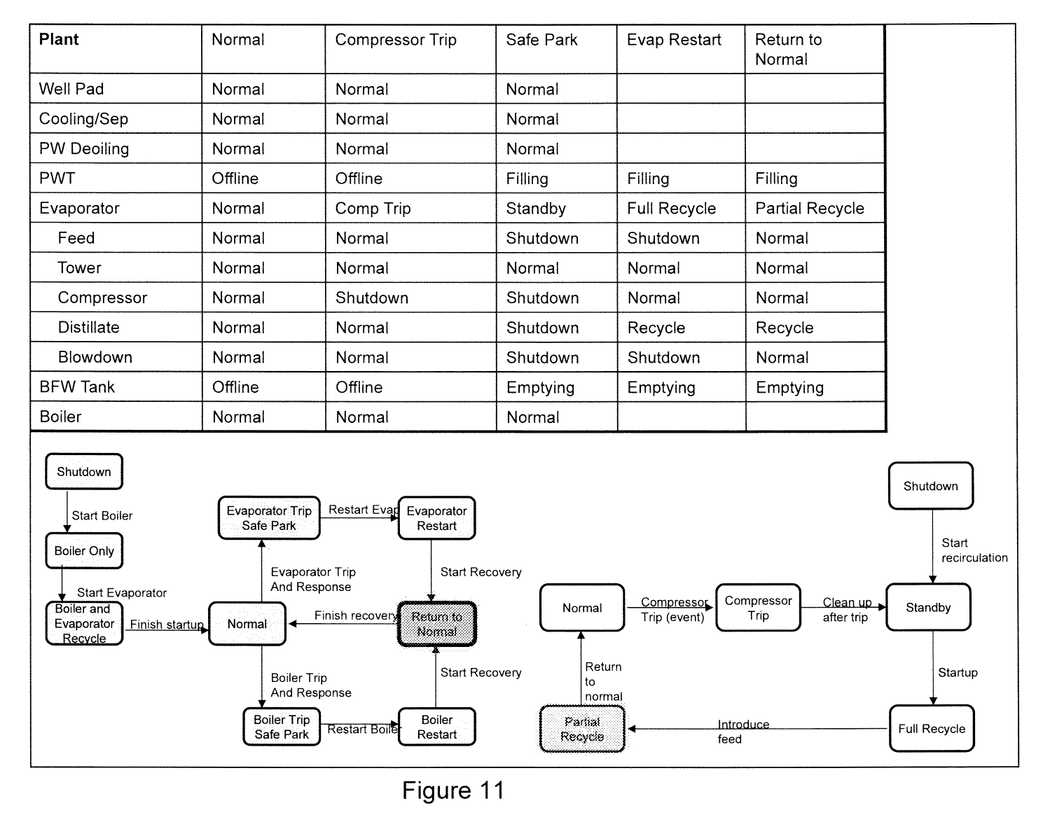

FIG. 11 illustrates additional steps to return to normal operation of the plant.

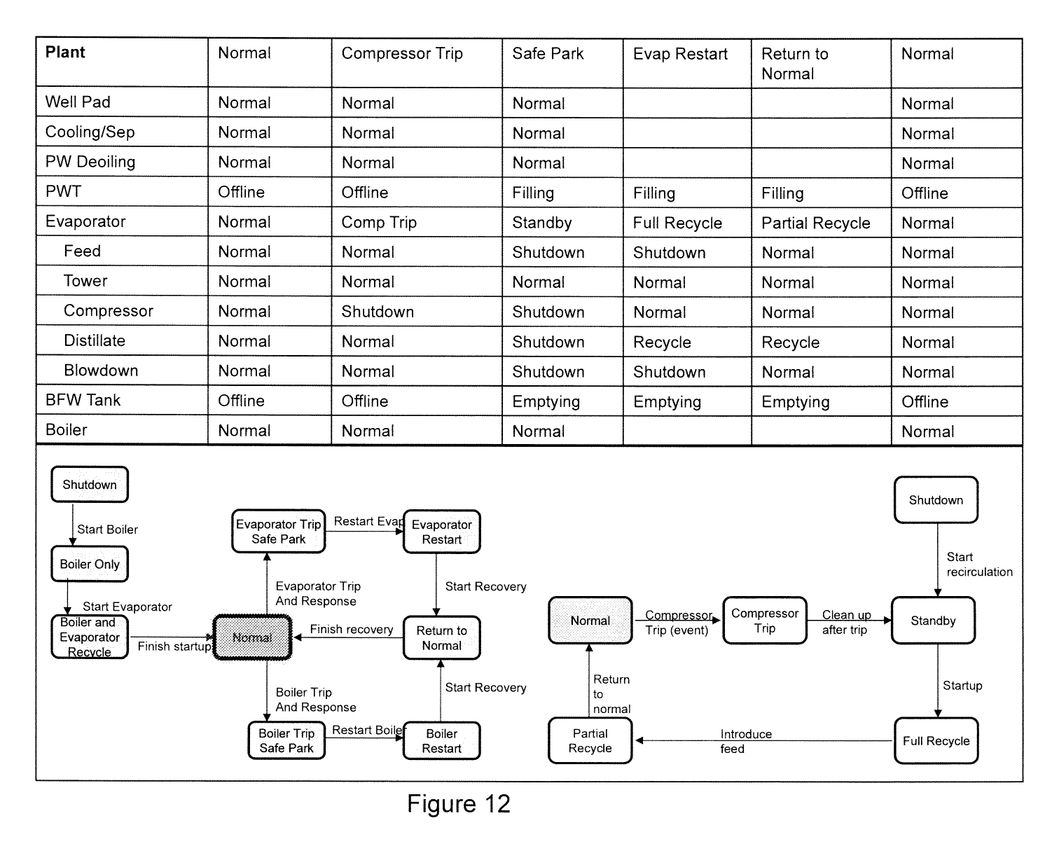

FIG. 12 illustrates a final state of the plant in the normal operational state.

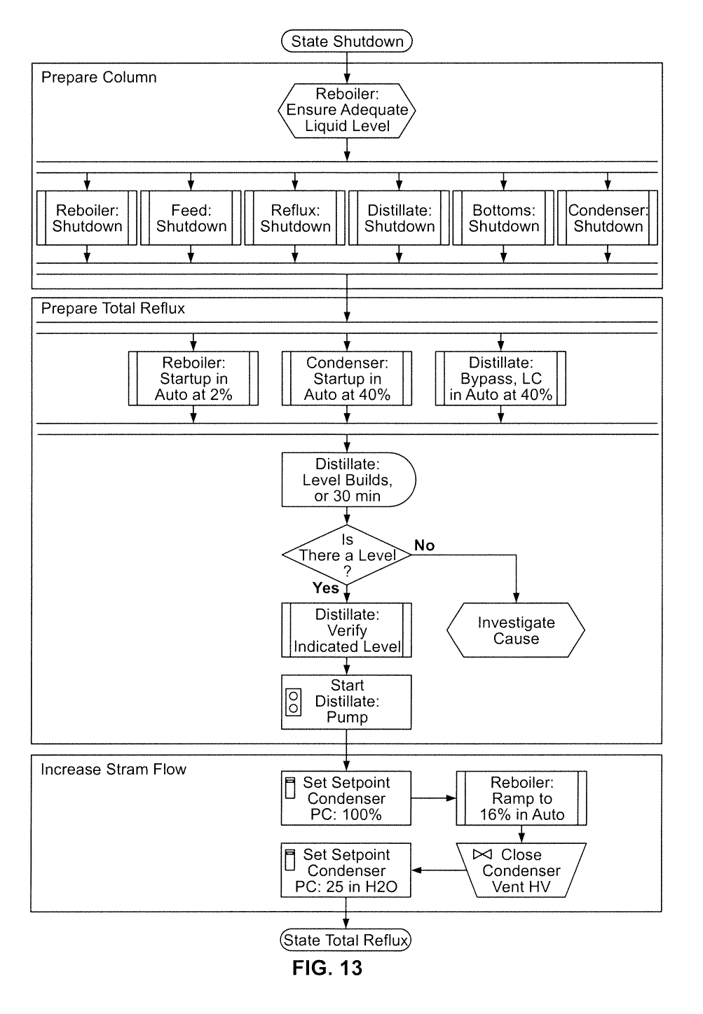

FIG. 13 illustrates an example of high and low level sub-procedures.

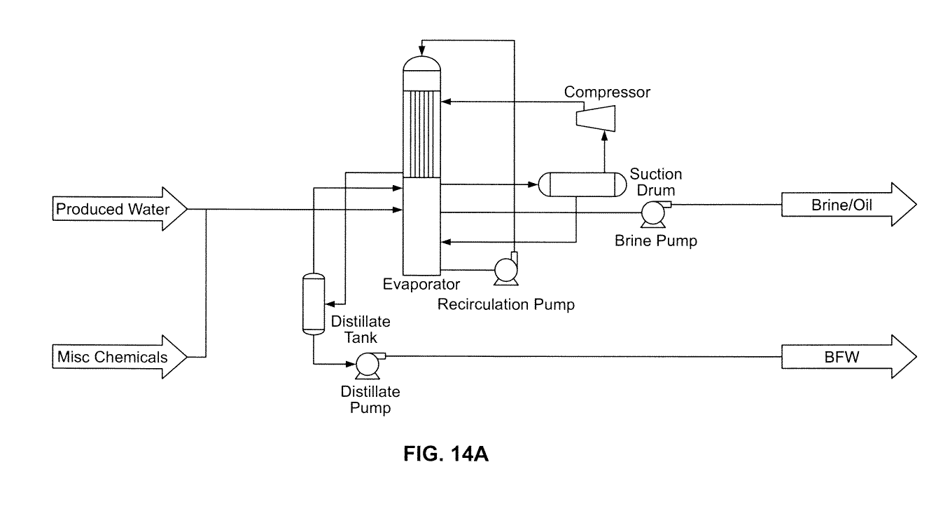

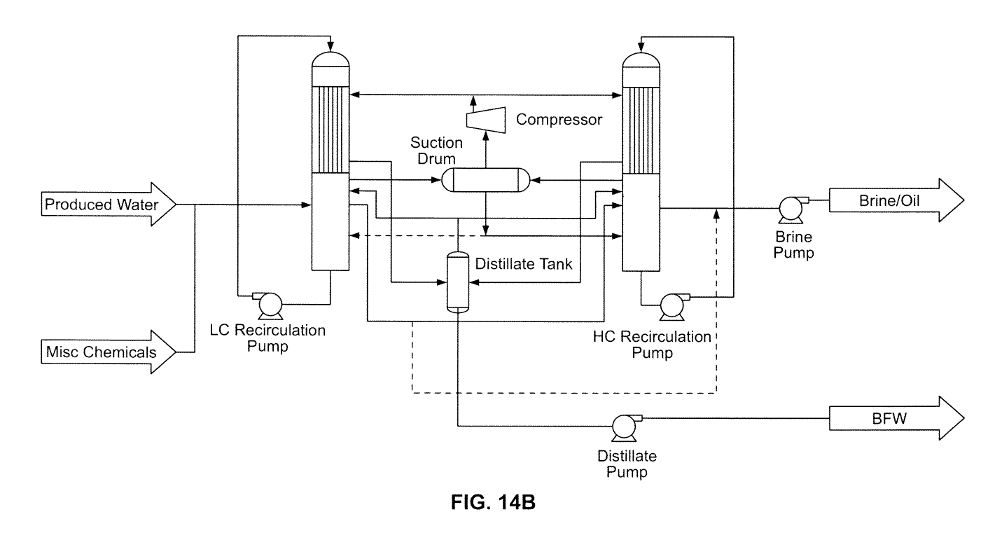

FIGS. 14A and 14B illustrate two types of evaporator designs having several common elements.

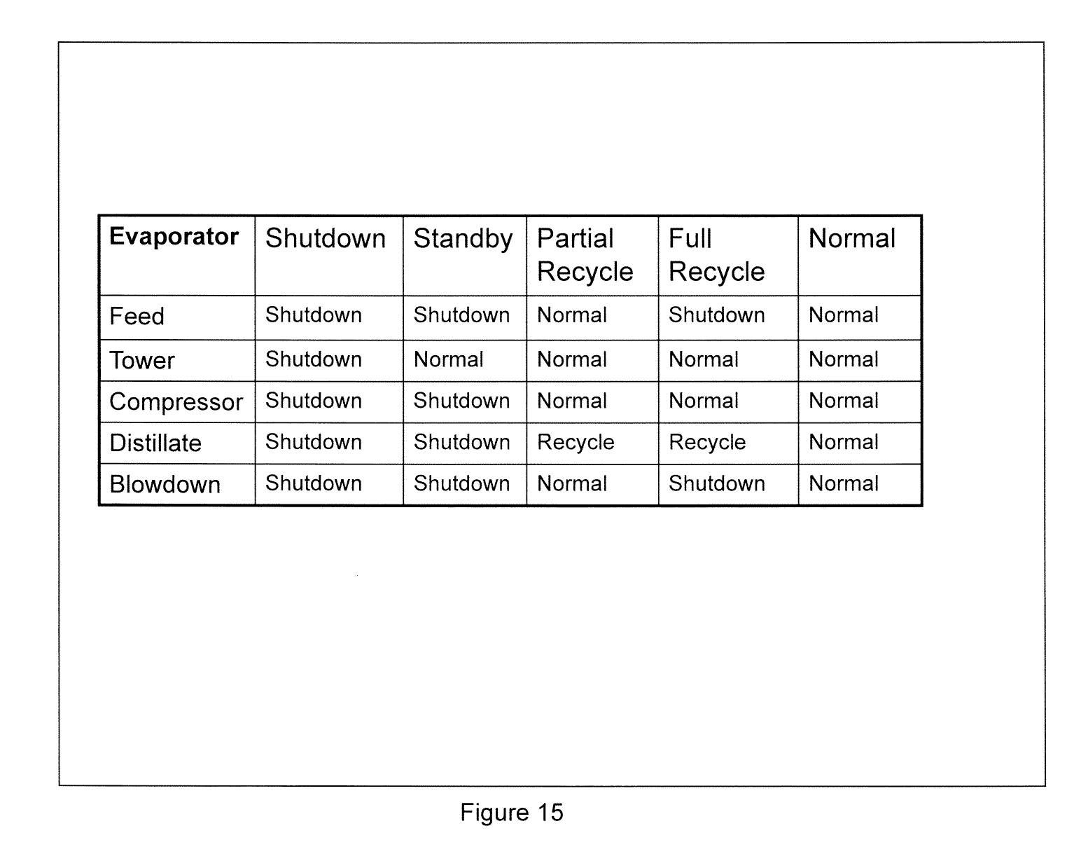

FIG. 15 illustrates some of the modes in which the equipment modules can exist.

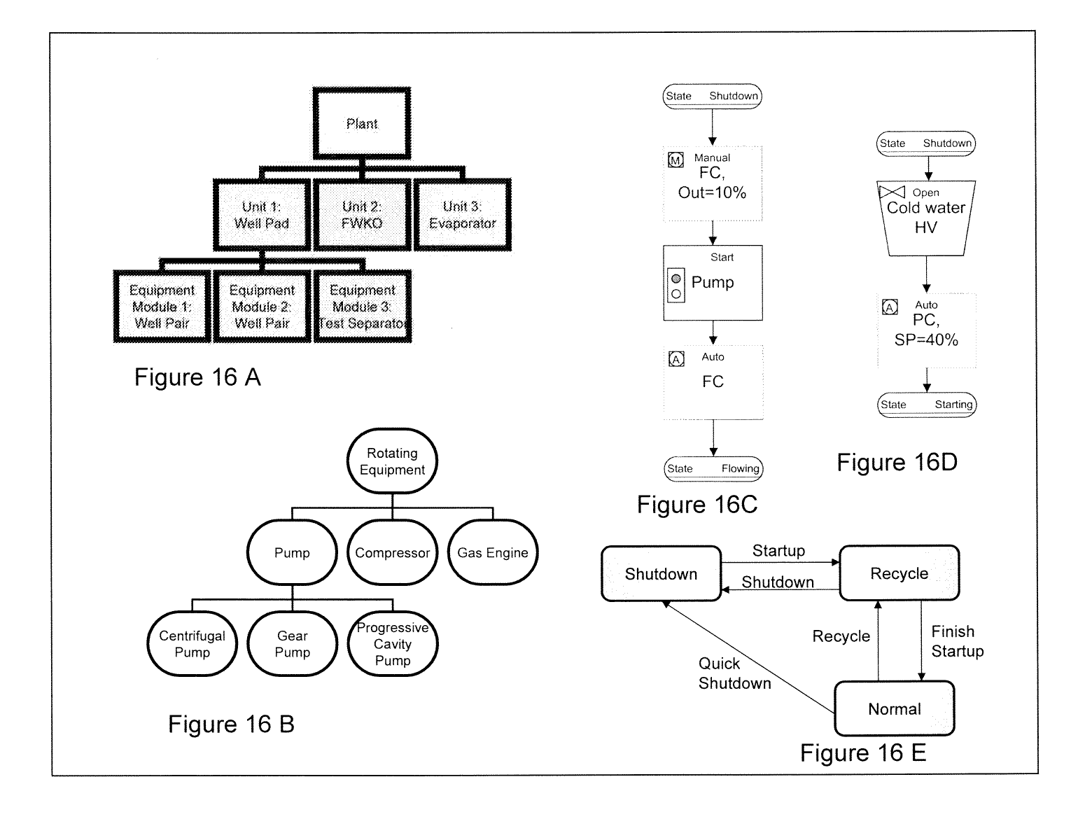

FIGS. 16A-E illustrate methodology of the process.

FIG. 17: Shows an ANSI/ISA 88.00.01 Physical Model

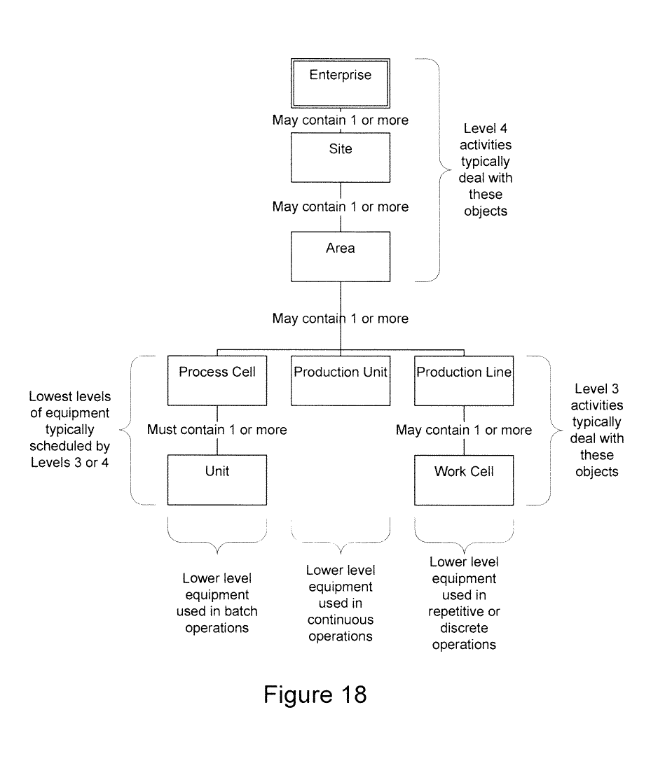

FIG. 18: Shows an ANSI/ISA 95.00.01 Equipment Hierarchy Model

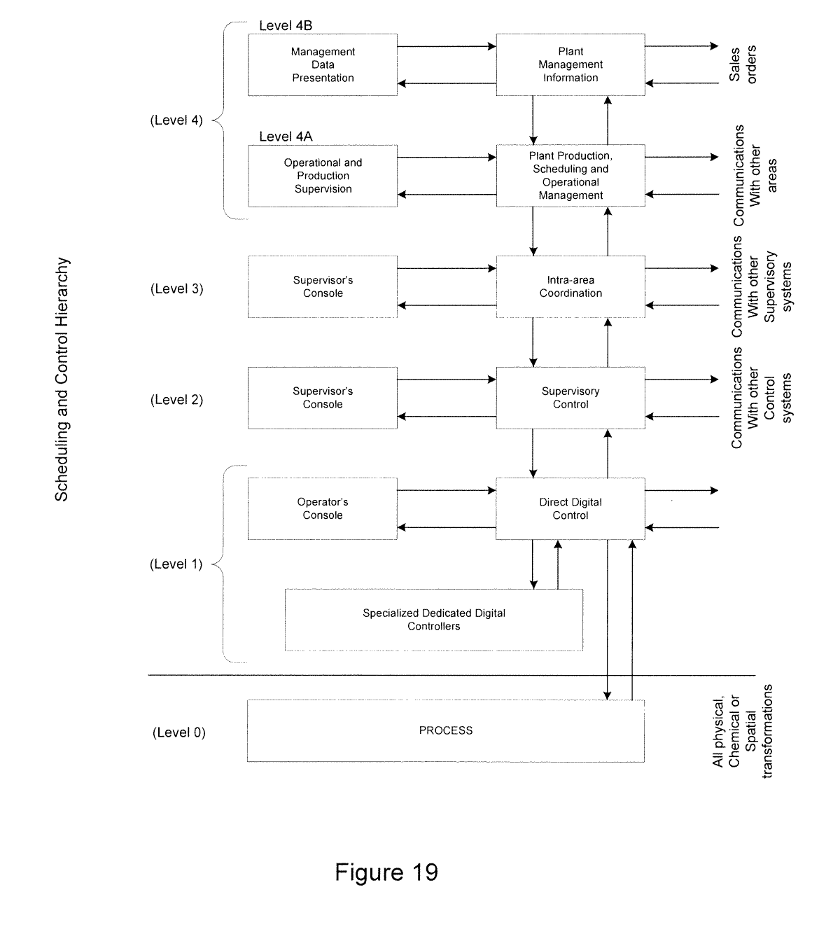

FIG. 19: Shows an ANSI/ISA 95.00.01 Diagram D2, representation of the Purdue Reference Model for CIM, for continuous processes

FIG. 20: Illustrates a decomposition of a distillation column according to the ANSI/ISA-88 methodology

FIG. 21: Illustrates modes and transitions for distillation column

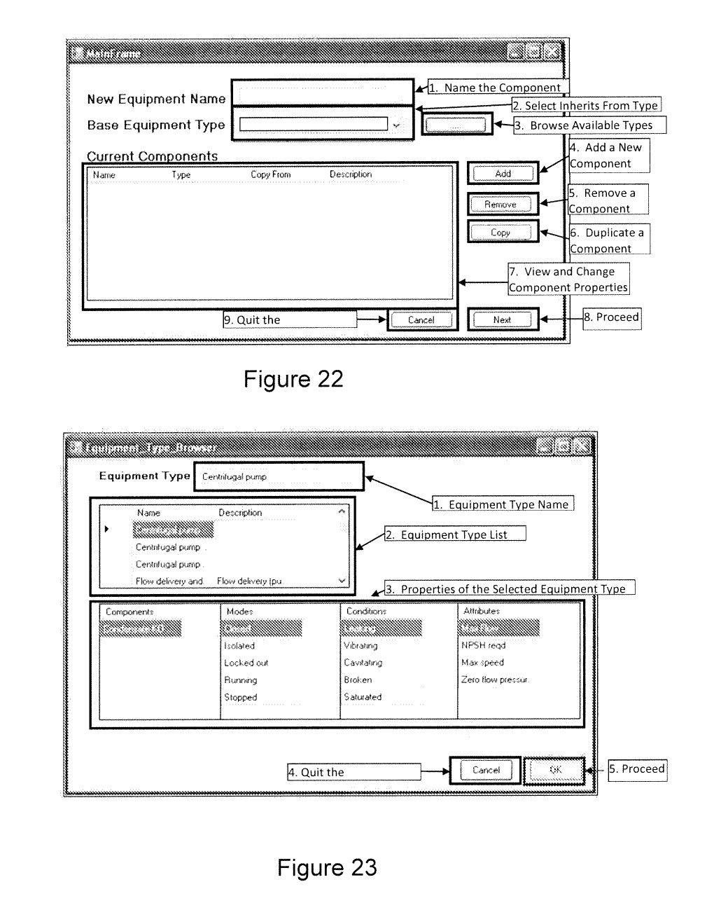

FIG. 22: Shows a sample screen for an Initial Window for Adding an Equipment Type

FIG. 23: shows a sample screen for Equipment Type Browser

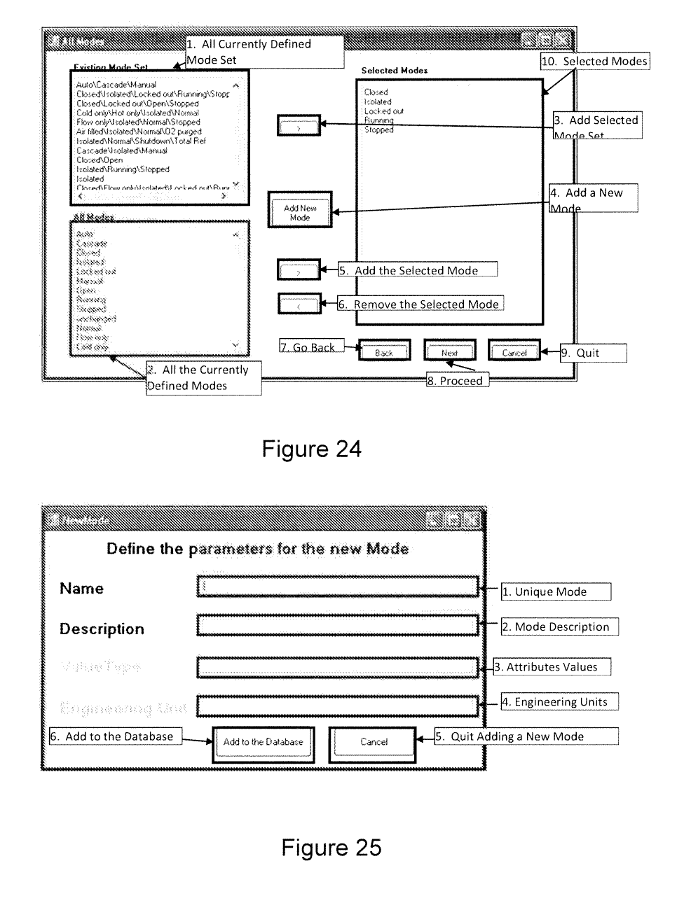

FIG. 24: shows a sample screen of a window for Editing the Modes

FIG. 25: shows a sample screen of a window to add New Modes

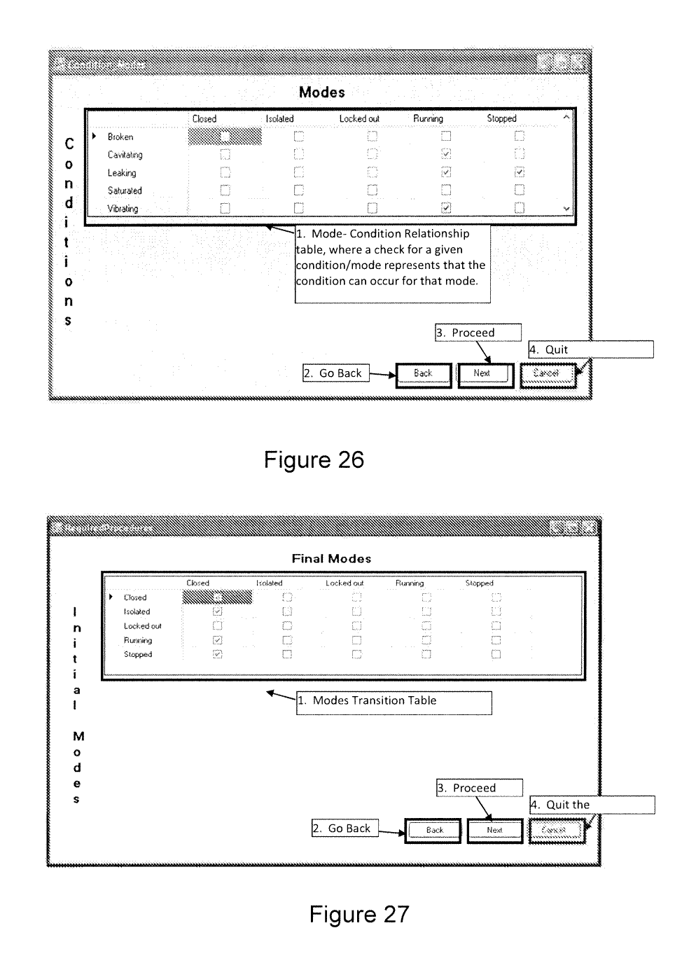

FIG. 26: shows a sample screen of a window for Editing the Mode-Condition Relationships

FIG. 27: shows a sample screen of a window for Editing the Mode Transitions

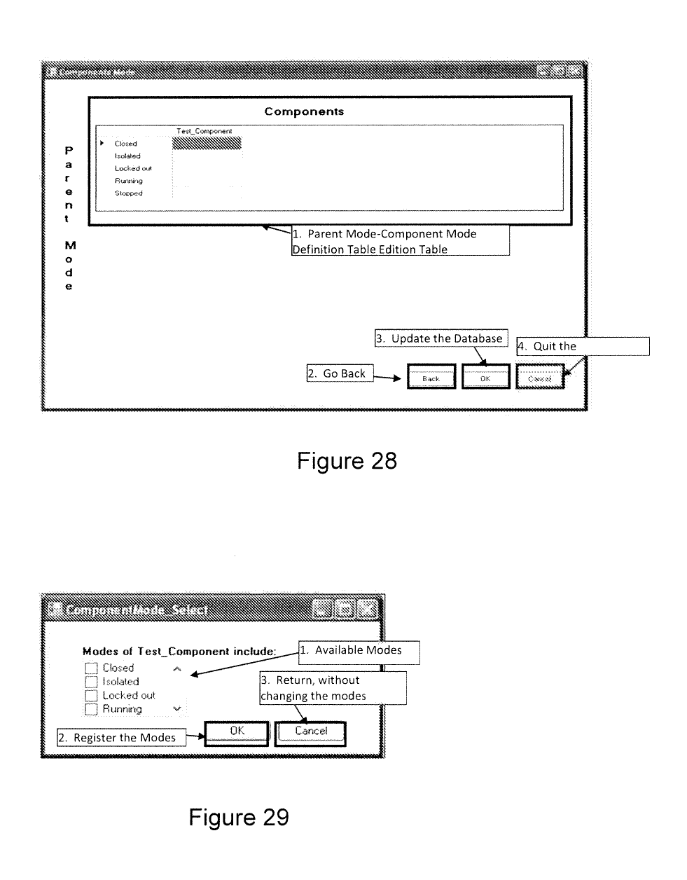

FIG. 28: shows a sample screen of a window for Editing the Parent Mode-Component Mode Relationships

FIG. 29: shows a sample screen of a window for Component Mode Selection

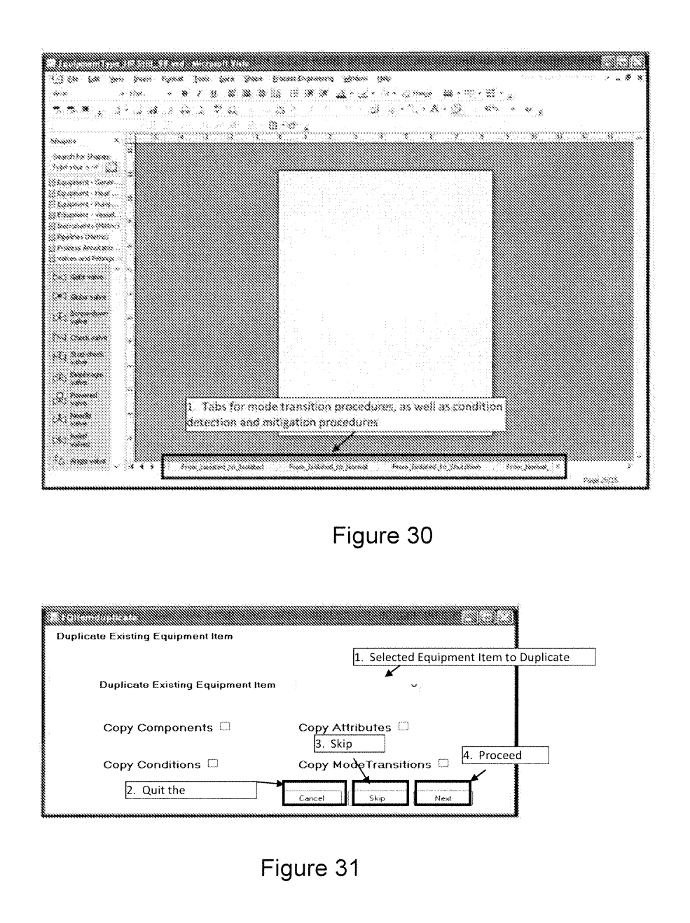

FIG. 30: shows a sample screen of a window of Visio files for the added equipment type

FIG. 31: shows a sample screen of an Equipment Item Duplication window

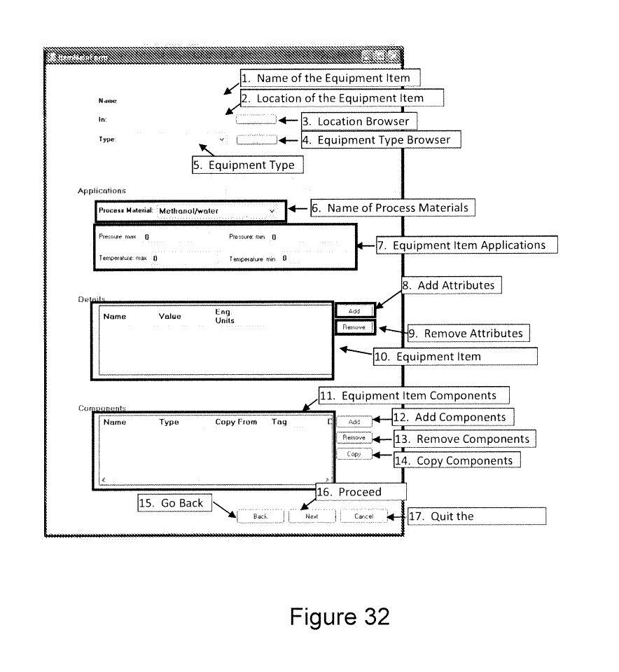

FIG. 32: shows a sample screen of Equipment Item Main Window

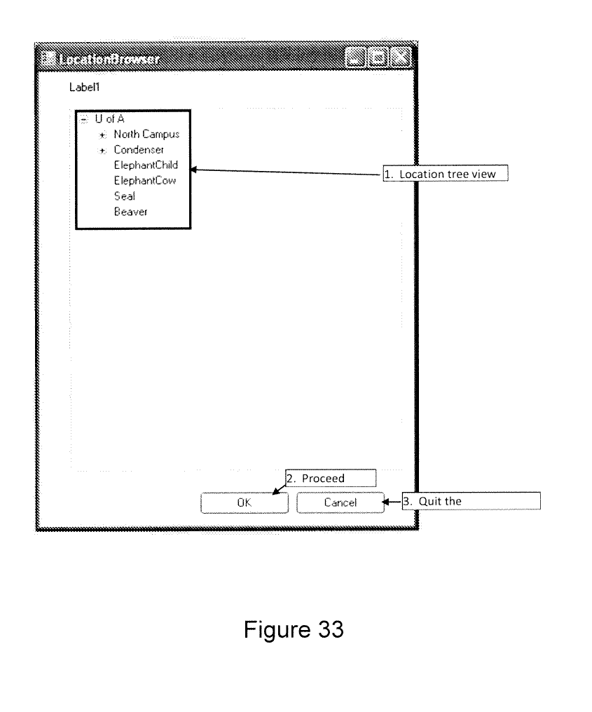

FIG. 33: shows a sample screen of a window for selecting location

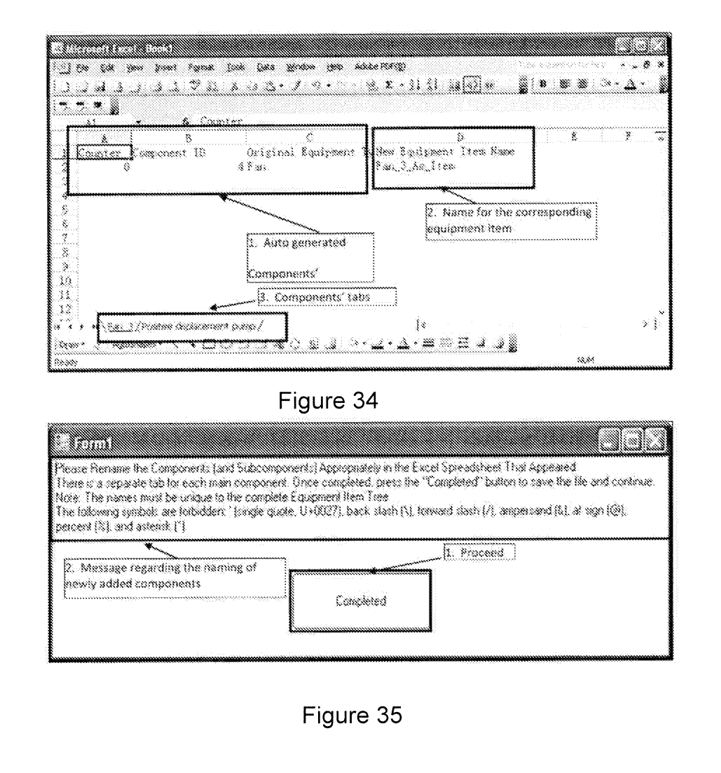

FIG. 34: shows a sample screen of an Excel spreadsheet for the components

FIG. 35: shows a sample screen of a Dialogue window for the components

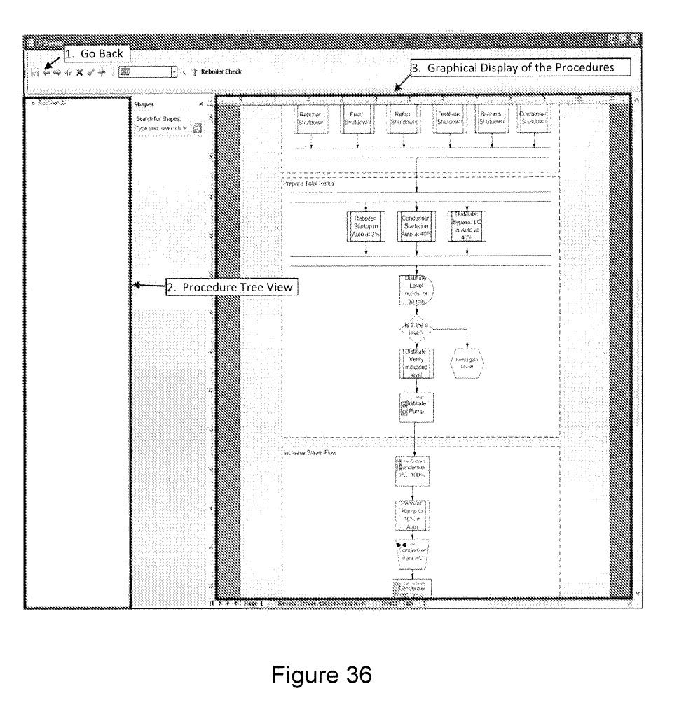

FIG. 36: shows a sample screen of an Operation Procedure Viewer

### DETAILED DESCRIPTION OF THE PREFERRED EMBODIMENTS

Referring generally to the figures, the following components and parts make the embodiments of the invention:

Software: database, plant configuration interface, procedure definition user interface, procedure viewing/printing interface.

The database retains information. A skilled user uses the configuration interface to define the object classes, the plant hierarchy, modes and conditions, etc. A somewhat less-skilled user uses the procedure definition user interface to define the procedures, and an operator uses the viewing/printing interface to read the procedures and, as required, print off copies of procedures and reports.

There is significantly less duplication of effort, since a given plant contains many similar pieces of equipment that require their own procedures. This system would require only one procedure per type of equipment instead of one per piece of equipment.

Similar-but-different pieces of equipment would share some modes and some procedures, which would be defined at the highest level in the class hierarchy, further reducing the number of procedures required.

The use of modes allows the procedures for changing lower-level objects to be left in the abstract while writing the high-level procedures. The lower-level procedures may be used in multiple locations, and, again, only need to be written once.

The main benefit accrues as procedures need to be revised. At present, written procedures are typically revised only after a few years, and thus are always out of date. This method would greatly reduce the amount of work required to update a procedure, and would make the review/approve process much more efficient, and hence faster.

It will be far simpler to adapt existing procedures for a new plant, even a quite different one, as long as the basic low-level equipment is similar. Since plants are assembled from off-the-shelf equipment and unit operations, there is considerable commonality among operating procedures.

The configuration of procedures and sub-procedures is well-suited to the use of flowcharts and visual tools, which permit more validity checking than plain text. It is also simple to automate the process to translate a flowchart into structured text. This would allow procedures to be defined more efficiently by operators, who are often primarily visual thinkers and not highly skilled at technical writing.

Both graphical/flowchart and textual representations can be used and presented to the operator, as they have complementary strengths. I am not aware of any product out there that does this, but some may exist.

Many variations are possible in how procedures are written and presented. The use of flowcharts to define the procedures is only the preferred option.

There are alternatives to how the plant can be decomposed. It is not necessary to use the ANSI/ISA 88 model, for example. Others exist. For example, an ISA committee, ISA 106, is currently working on a model specifically for procedure automation in continuous processing. ANSI/ISA 95 has an alternative hierarchy for continuous processing, and other approaches and terminologies for determining the hierarchy probably exist

Many of the abovementioned features are not strictly required. It is probably not essential to have a hierarchy of object classes, or for that matter to use object classes. There would still be some value if common procedures were used only where the equipment was essentially identical, although it would be much reduced.

The use of conditions is not essential. Modes are essential. The use of conditions allows procedures to manage alarms to be included. The definition of “applicable modes” is also not essential.

Transitions between different modes are essential. Transitions that return to the same mode are not essential.

The formalism in the relationships between the modes of lower-level and higher-level objects is essential.

Defining procedures in terms of equipment types is essential.

Defining modes and procedures at different levels of the equipment hierarchy is essential.

The masking of lower-level details, by having procedures refer to sub-procedures primarily in terms of the lower-level modes, is essential, but it is also essential that a procedure is allowed to interact with sub-procedures located more distantly in the equipment hierarchy than an immediate neighbour. This is an important point: the equipment hierarchy is a tool for organizing our thoughts about the plant: it does not constrain how procedures interact. For example, when starting a car with an automatic transmission, you have to put your foot on the brake before shifting into Drive from Park. It is more direct to say “put your foot on the brake pedal” than “put the brake system into ‘applied’ mode”. (The language used in practice would not be excessively formal. This is just an example of a procedure going straight to the sub-sub-component—the brake pedal—instead of working at the component level—the brake system.)

This is also an apparent weakness of the ANSI/ISA 88 model: the equipment hierarchy enforces the control hierarchy.

One significant difference between the new method and the ISA-S88 methodology is that an item may have multiple parents.

The use of flowcharts, and especially the particular format used in the prototype software, is not essential.

The ability to define parameters for procedures is essential, although not every procedure will require parameters.

The ability to define attributes for an object class is essential.

The conversion of a flowchart to text is not essential, but is strongly preferred, since the textual representation contains more information in less space than a flowchart.

The ability to define procedures for a single specific piece of equipment, rather than always force the use of a class, is not essential, but is strongly preferred.

The ability to “refactor” or revise the organizational structure of the plant hierarchy and procedures, is not essential.

The generation of reports for management, to measure progress and compliance, is not essential.

Need to find a way to reduce the amount of work required to write and update procedures.

More efficient procedure management:
Reduce the amount of duplication between procedures
Find a way to determine what procedures need to be written
Find a way to expose or conceal detail as desired by the operator.

Will result in more accurate, complete, up-to-date procedures.

A prerequisite for automation of startups, shutdowns and other operating procedures.

2. Hybrid Systems

A hybrid system is one with discrete and continuous states.

A Continuous state has continuously varying values: setpoint, temperature, pressure, etc.

A Discrete state has a limited set of values: on/off, 1, 2, 3 etc.

Real plants are hybrid systems. Linear system models are inadequate for modeling operating procedures.

What are the issues?

A real plant has thousands of pieces of equipment, each with its own set of states
Those states contribute to the overall states—a combinatorial problem
The procedure will need to touch most of them

A Better Way:

Object-Oriented Procedures
Procedures are programs executed by people.
Use the methods of object-oriented software design and management to write and manage operating procedures, as well as to automate them

1. Composition

Big, complex objects are composed of simpler objects.
An area is made up of units, which are in turn composed of equipment modules and control modules.

Industrially: ANSI/ISA 88 describes how to do this.
And modern control systems know how to make use of it.

Procedures for the big object (unit) can be defined in terms of the simpler objects (equipment modules) that make it up, or compose it.
To start up a distillation column, you start the feed, the condenser and the reboiler, each of which have their own procedures

Decomposing a Plant:

### Process Units

### Decomposing a Unit:

### Evaporator

### Decomposing an Equipment Module:

### Evaporator Distillate Module

Procedures can be written for equipment—and unit—types, not just specific items, at all levels of the hierarchy.
SOP's usually exist at the very lowest level. Extend this thinking to higher levels in the hierarchy.

2. Object, Class and Inheritance

All pumps are pumps.
Centrifugal pumps are a type (or class) of pump.
All pumps have some things in common.
All centrifugal pumps have somewhat more in common.
There are sub-types of centrifugal pump (subclasses).

Procedures can be defined at the class level and used for all equipment of that class.
Written once, used many times

They can (and should) be written for the parent class when possible.
Further reuse of procedures

Equipment types can be defined at different levels—unit, sub-system as well as atomic.

Low-Level Equipment Modules

There are only so many appropriate ways to set up
Surge tanks and pumps,
Storage tanks,
Heat exchangers

These “design patterns” have standard operating procedures.
Write once, maintain in a central location, publish for specific equipment.
Next Question: how do we tie the procedures for these common subsystems into the overall procedures for the plant?

3. Real plants and equipment have distinct operating modes

Example: A simple distillation column
Many continuous states
Discrete states: operating mode, fault conditions
Operating Procedures are the instructions for changing values of the discrete states (control algorithm)

Modes are meaningful
Different sets of governing differential/algebraic equations
Different impact on production
Different potential fault conditions, and hence different alarms
Operators have names for them

### Modes and Statechart Plant Level

### Modes and Statechart, Unit Level

### Evaporator

Encapsulation
The higher level object (unit: distillation column) does not need to know the details of the lower level object (equipment item: pump). It just needs to know its state, and what procedure to call to change its state.
Internal details are just that—internal to the lower level.
Each level in the hierarchy conceals its internal details from the level above it.

Subprocedures
High-level procedures are largely, if not completely, defined in terms of mode changes of components: subprocedures
Higher level procedures mostly refer to lower-level procedures, without knowing their internal details
Changes can be made at one level without affecting other levels.
Procedures can be written for equipment—and unit—types, not just specific items, at all levels of the hierarchy.

Modes, conditions and procedures
Modes and fault conditions define the procedures that are required
Plant hierarchy allows modes and procedures to be defined one level at a time
Lower-level modes/conditions affect higher-level modes/conditions
   “Causality flows up”
   There is not a one-to-one relationship between lower-level modes and higher-level modes.
Higher-level procedures affect lower-level modes
   Procedure actions mostly call for lower-level systems to change mode.
   “Commands flow down”

Exchanger Evaporator Design

### Unit and Equipment Module Modes: Different Configurations

Unit modes are the same.
Modes of components are the same.
Low-level Equipment Module procedures are the same.
Only the arrangement is different—there are now 2 Towers
Minor changes, confined to the relevant level in the procedure—unit.

We can now manage procedures—define the hybrid control algorithms—for many plants.

The procedures have only minor differences.

Equipment hierarchy
Higher-level procedures refer to (“call”) lower-level procedures

Encapsulation
Higher-level equipment/procedures do not need to worry about lower-level details

Common low-level design patterns
Standard low-level procedures

Equipment (object) types
Define procedures at “type” level, not specific equipment item
Class hierarchy allows further re-use of procedures

Modes and Conditions
Determine the set of procedures we need
Direct tie-in to alarm management

Steps
Define plant hierarchy
Define class hierarchies
Define state machines (modes and transitions) for object classes
Write (or re-use existing) procedures for low-level object classes
Write procedures for higher-level classes in terms of mode changes of lower-level object classes (subprocedures)
Class procedures are combined with specific equipment in plant hierarchy to produce actual, working procedures
Present procedures to the detail requested by the operator
Following an incident, revise (and review) only the part that needs it—for the class, not the instance?

Manage procedures as software, not plain text documents.

Present procedures to operators specific to equipment, but write them generic.

Equipment Type

Equipment Type Creation

In this version of procedure automation, new equipment types can be easily defined. The screenshots below explain the main windows that appear and how to deal with them.

The first step in creating a new equipment type is to enter the basic information about the process. This can be done in the window shown in FIG. 22. The new equipment type name is entered in Box 1. It should be noted that the name must be unique and must not contain any of the following letters: (single quote, U+0027), back slash (\), forward slash (/), ampersand (&), at sign (@), percent (%), and asterisk (*).

Next, the parent of the new equipment type must be selected (Box 2 or Box 3). If it is known what existing equipment type is to be selected, the desired type can be selected from the drop-down box (Box 2). On the other hand, if it is desired to browse for the parent type, then the user can click on Box 3 and a new window (shown as FIG. 23) will be displayed, from which it is possible to select the parent equipment type. It should be noted that doing this will reset any previously selected components. The parent type determines the default (or initial) components, modes, attributes, conditions, mode transition table, mode-condition table, and parent mode-condition table. These values can be changed by the user.

The Equipment Browser window, which is shown in FIG. 23, can be used to search for desired type that is going to be considered as the parent (base) type of the newly added equipment type. When the name of an equipment type is entered into Box 1 in FIG. 23, all of the currently available equipment types that match the given name or inherit from the given name will be displayed in Box 2 in FIG. 23. Clicking on the items that is of interest will show all the relevant information (including components, modes, conditions and attributes), which will be displayed in Box 3 in FIG. 23. The buttons (Box 4, Box 5) at the bottom of the window enable the user to accept the selected equipment type as the parent (Box 4) or simply quit the current equipment browser without changing the parent type (Box 5).

Finally, the components for the new equipment type can be defined in the area defined as Box 7 in FIG. 22. For each component, a unique name with respect to components for a given equipment type that does not contain the aforementioned characters should be included. As well, a description can be added. New components can be added by clicking on the “Add” button (Box 4). When this is done, a new row will appear. The type must be selected before anything else is done, as selecting a new type will override any previous information entered to a given row. A component can be removed by clicking on the “Remove” button (Box 5, FIG. 22). This will remove the currently selected component (row). There is unfortunately no undo for this operation. A component can be duplicated by clicking on the “Copy” button (Box 6, FIG. 22). This will copy the current component (row) and create a default name, which can be changed. It should be noted that components that are inherited from the parent type cannot have their type changed; if it is desired to change their type, they must be deleted. Once all the desired data has been entered in this window, the “Next” button can be pressed and the further information about the new type can be added.

Three types of information, namely, modes, conditions and attributes, must be defined for the newly added equipment type. The interface for editing these properties is similar. FIG. 2 4 shows the interface for editing the modes, which consists of the selected modes panel (Box 10) and the currently defined modes (Box 1) and mode set (Box 2) panels. The user may choose to quickly add new modes to the selected modes panel from the currently defined mode sets by selecting a row in Box 2 and then clicking on the add button (Box 3). Individual modes can be added by selecting them in Box 1 and then clicking on the add button (Box 5). A mode can be removed by selecting the given mode in Box 10 and then clicking on the remove mode button (Box 6). A new mode can be added by clicking on the “Add New Mode” button (Box 4), which will bring up the window shown in FIG. 24.

When the “Add New Mode” button (Box 4) in FIG. 24 is clicked, a new window called “NewMode” appears, which is shown in FIG. 25. A unique mode name is entered in Box 1, while a short description of the given mode can be entered in Box 2. Clicking on the “Add to Database” button (Box 6) will enter the new mode into the database. Clicking on “Cancel” will close this window without making any changes to the database. If an attribute is being added then 2 addition pieces of information should be given. The data type of the attribute is specified in Box 3. The data type includes numeric or string. Finally, the (engineering) units of the given attribute should be entered in Box 4. If there are no units, then this box can be left blank. The rest of the procedure is the same for adding an attribute.

The conditions, which describe the possible faults associated with the given equipment type, and attributes, which describe the parameters of the given equipment type, such as height, width, length, and maximum flow rate, have an interface that is mutatis mutandi the same as for the modes shown in FIG. 24.

Having defined the modes, conditions, and attributes of the new equipment type, it is now necessary to define the interactions between the various modes, conditions, and components. The first window, which is shown in FIG. 26, allows the user to define the relationship between the modes and conditions, that is, which conditions occur for a given mode. Placing a check for the given condition/mode combination in Box 1 of FIG. 26 will select the given combination as being active. To proceed to the next window, click on the “Next” button (Box 3), which will bring up the Mode Transition window, shown in FIG. 27. To return to the previous attribute editing window, click on the “Back” button (Box 2). Finally, to quit the program, click on the “Cancel” button (Box 4).

Once the mode condition relationships have been defined, it is now necessary to define the mode transition table. This can be done in the window shown in FIG. 27. Similarly to before, placing a check for the given Initial Mode/Final Mode in Box 1 of FIG. 27 says that the given equipment type can go from the selected Initial Mode to the selected Final Mode. This table is important in that it will later define what transition procedures are required to be created. To proceed to the next window, click on the “Next” button (Box 3), which will either bring up the Parent Mode-Component Mode window, shown in FIG. 28, if there are any components, or the user will be asked to confirm that the new equipment type is to be committed to the database. To return to the mode-condition editing window, click on the “Back” button (Box 2). Finally, to quit the program, click on the “Cancel” button (Box 4).

If there are any components associated with the equipment type, then the final step is to define the relationship between the parent modes of the equipment types and the required component modes. The window for defining the Parent Mode-Component Mode relationships is shown in FIG. 28. There is a column in Box 1 for each component and a row for each parent mode. Clicking on any of the cells in Box 1, will bring up a window, shown in FIG. 29, that will allow the user to select the appropriate modes for the given component. The available modes that can be selected are given in Box 1 of FIG. 29. It should be noted that clicking on “OK” (Box 2) will override any previous selection, while clicking on “Cancel” (Box 3) will return to the Parent Mode-Component Mode table without making any changes. To commit the changes to the database, click on the “Next” button (Box 3). To return to the previous mode transition editing window, click on the “Back” button (Box 2). Finally, to quit the program, click on the “Cancel” button (Box 4).

Visio Files

In the final step of equipment type creation, a summary Visio file is created in which three types of information are included: procedures for modes transitions, procedures for detecting a given condition, and procedures for mitigating a given condition. Based on the setting in Mode transition table, the Visio tabs are automatically generated based on the transition path that has been specified. Furthermore, with all the conditions associated with each of the equipment type, tabs for detecting and mitigating different conditions are also generated in which the procedures for each of the actions (detection and mitigation) are illustrated. FIG. 30 shows the sample Visio file generated for a newly added equipment type.

Equipment Type Modification

Equipment type modification is supported in the current version of Procedure Automation. The same procedure can be followed for modifying an equipment type as was followed for creating a new equipment type. It should be noted that all the previously defined equipment type information will be displayed in each of the windows. However, it should be noted that renaming a component can lead to a loss in the link between the component and its parent mode-component mode relationships.

Equipment Item

Equipment Item Creation

An equipment item represents a specific instance of a given equipment type. Since it is common to have multiple nearly identical items present in a plant, the ability to duplicate an existing equipment item is important. Thus, when the user wishes to create a new equipment item, the first window that appears, shown in FIG. 31, allows the user copy an existing equipment item. The desired equipment item to be duplicated is selected from the drop-down box (Box 1). It is also possible to determine what parts of the duplicated equipment item are to be copied. The choices are components, attributes, conditions, mode transitions. To proceed and duplicate the selected equipment item, click on “Next” button (Box 3). To add new equipment item without duplicating a previous equipment item, click on the “Skip” button (Box 3). To quit the program, click on the “Cancel” button (Box 2).

FIG. 32 shows the main window for defining the parameters for the equipment item. In Box 1, the equipment item name can be entered. It must be unique to the given location and must not contain any of the following letters: (single quote, U+0027), back slash (\), forward slash (/), ampersand (&), at sign (@), percent (%), and asterisk (*). The location of the equipment item must be specified using the Location Browser which is shown in FIG. 33. By clicking on the root node, the tree view (Box 1, FIG. 33) is expanded with more information concerning the possible locations being displayed. The select node determines the location of the process as well as the process material.

If the equipment type was duplicated, then the equipment type cannot be changed. On the other hand, if a new equipment item is being defined, then the equipment type must be defined using the Equipment Browser (Box 4, FIG. 32), which is similar to the Equipment Browser previously explained. The selected equipment type will define the base defaults for all the modes, conditions, and attributes, as well as their interactions.

The process material for the equipment is defined in the drop-down box in the Applications panel (Box 6). By default, it is defined based on the location selected. However, if the there is no predefined process material for the given location, then the user can select the appropriate process material. As well, in this panel, the maximum and minimum temperatures and pressures can be assigned. It needs to be noted that the engineering units for the temperatures and pressures are determined by the users when different values are input for the entries.

In the Details panels in FIG. 32, the specific values of attributes can be defined in Box 10. As well, a new attribute can be added by clicking “Add” button (Box 8). Entries for the “Name”, “Value” and “Eng. Unit” would be added upon clicking the “Add” (Box 8) button. All the existing details of the equipment items are retrieved from the database and displayed in the—drop-down button sits under the “Name” category. For the purpose of consistency, the value for “Eng. Units” category is combined with different details, therefore, once the name of the detail has been given, the relevant engineering units value would also be fixed accordingly. A selected attribute can be deleted by clicking on the “Remove” button (Box 9).

In the Components panel in FIG. 32, the equipment items for the corresponding components can be defined. Three different types of actions could be taken in this part, namely, “Add Components” (Box 12), “Remove Components” (Box 13), and “Copy Components” (Box 14). Clicking on the “Add Components” button, a new row would be inserted with blank entries for different types of properties associated with the newly added components. Either the “Copy from” or “Type” column value should be first selected as changing the values here will erase any other information that is selected. If “Type” is selected then any equipment type can be selected as the base class type to create a new equipment item. If “Copy from” is selected then an equipment item can be selected that will be the basis of the new equipment item component. It should be noted that selecting either of the buttons will cause the other button to be disabled. The component name (which may be different from the equipment item name) should be entered in the “Name” column. Finally, the tag and any comments should be entered in the appropriate columns of the new component. Clicking on the “Remove Components” button will delete the currently selected row/component. Finally, the “Copy Components” button will create a copy of the currently selected row/component. This allows for easy duplication of components.

Once all the information has been entered in this window, the user can proceed to the next task by clicking on the “Next” button (Box 16, FIG. 32. If any components were newly defined, an Excel spreadsheet, which is shown in FIG. 34, and a dialogue box, which is shown in FIG. 35, will appear. For each component, there will be a separate Excel sheet. The information in Box 1 in FIG. 34 is not meant to be changed. However, since it is assumed that each component must be associated with a unique equipment item, the rows in Box 2 allow the user to enter a unique name that is to be given to the newly created equipment item. A default unimaginative name that is potentially not unique is provided (It can be noted that at present the values in the Excel spreadsheet are not used by the program to create the names. Instead, unimaginative unique names are used that can potentially cause name length issues).

Once all the values have been entered into the Excel spreadsheet, the “Completed” button on the dialogue window (Button 1, FIG. 35) should be clicked. It is important to note that the Excel spreadsheet should not be closed manually. The computer program will close and save the data itself in a desired location. The rest of the procedure is the same as for adding a new equipment type. It should be noted that the values obtained here should not change as this may present issues with the creation of the appropriate Visio files. As mentioned in “Equipment Type Creation” section, the settings of the generated Visio files are consisted of two parts: tabs for the modes transitions and tabs for condition detection and mitigation.

Equipment Item Modification

Equipment item modification is supported in the current version of Procedure Automation. The properties associated with the existing equipment items can be modified under different categories as discussed in “Equipment Item Creation” section. After selecting an equipment item from the list, the user may change the components, modes, conditions, attributes, modes-conditions combination and modes transition path by going through all the same procedures as given in “Equipment Item Creation” section. Once all the necessary changes have been made, click the “Next” button and the database will be updated based on the modifications the user just made.

Operation Procedure Viewer

Operation Procedure Viewer displays the procedures that have been specified for each of the items. Currently, the functionality of this part has not been fully realized and it is still under construction. However, to give some idea of the interface, a screen shot of the interface is given in FIG. 36.

Examples and Unit Testing

Create a New, Basic Equipment Type
1) Create a new equipment type named “Flow.”
   a. Under Equipment Type, let “Flow” inherit from the “General Equipment” type.
   b. Set “Closed”, “Saturated”, and “Open” as the modes. If the given mode is not present, then add it.
   c. Set “Leaking” and “No Flow” as the conditions. If the given condition is not present, then add it.
   d. Set “Max Flow”, “Ammonia Composition”, “Water Composition” and “Carbon Dioxide Composition” as the attribute. If the given attribute is not present, then add it.
   e. Create the mode-condition table based on the information in Table 1, where Y represents that the given combination should be selected and N/A represents that the given combination should not be selected.

TABLE 1
Mode-Condition table: Y represents that a given combination
exists, while N/A represents that a given combination is not applicable.

| Mode | | | |
|---|---|---|---|
| Condition | Closed | Saturated | Open |
| Leaking | Y | Y | Y |
| No Flow | Y | N/A | Y |

f. Create the mode-transition table based on the information in Table 2, where Y represents that the given combination should be selected and N/A represents that the given combination should not be selected.

TABLE 2
Mode Transition table: Y represents that a given combination
exists, while N/A represents that a given combination is not applicable.

| | Mode | | |
|---|---|---|---|
| Mode | Closed | Saturated | Open |
| Closed | Y | N/A | Y |
| Saturated | Y | Y | Y |
| Open | Y | Y | Y |

g. Commit this equipment type to the database. Note that the Visio files are created automatically.
h. Verify that the database contains the information as specified. As well, check that the Visio file contains a page for each feasible mode transition, while there are 2 pages for each condition (Detect CONDITION and Mitigate CONDITION). If it is desired add the relevant procedures to the Visio files.

Creating a New, Composite Equipment Type
1) Create a new equipment type named: “Distillation Column.”
   a. Under Equipment Type, let “Distillation Column” inherit from the “General Equipment” type.
   b. Select add a single flow type component for the new equipment type. Set the name of the component to be “Feed.”
   c. Set “Shutdown,” “NormalOp,” and “TotalRef” as the modes. If the given mode is not present, then add it. It should be noted that the names of the modes should be less than 50 characters long.
   d. Set “Oscillating” and “Flooding” as the conditions. If the given condition is not present, then add it.
e. Set “Efficiency” in %, “Column type” as text, and “Height” in m as the attributes. Add “Top product” in %, “Bottom product” in % as the attributes. If the given attribute is not present, then add it.
f. Create a mode-condition table based on the information given in Table 3, where Y represents that the given combination should be selected and N/A represents that the given combination should not be selected.

TABLE 3
Mode-Condition table: Y represents that a given combination
exists, while N/A represents that a given combination is not applicable.

| Mode | | | |
|---|---|---|---|
| Condition | Shutdown | NormalOp | TotalRef |
| Oscillating | N/A | Y | Y |
| Flooding | N/A | Y | Y |

g. Create the mode transition table based on the information in Table 4, where Y represents that the given combination should be selected and N/A represents that the given combination should not be selected.

TABLE 4
Mode Transition table: Y represents that a given combination
exists, while N/A represents that a given combination is not applicable.

| | Final Mode | | |
|---|---|---|---|
| Initial Mode | Shutdown | NormalOp | TotalRef |
| Shutdown | Y | Y | N/A |
| NormalOp | Y | Y | Y |
| TotalRef | Y | Y | Y |

h. Create the component-parent model table based on the information in Table 5.

TABLE 5
Component-parent mode table

| Component | |
|---|---|
| Parent Mode | Feed |
| Shut Down | Closed |
| Normal Operation | Open |
| Total Reflux | Open |

i. Commit this equipment type to the database. Note that the Visio files are created automatically.
ii. Verify that the database contains the information as specified. As well, check that the Visio file contains a page for each feasible mode transition, while there are 2 pages for each condition (Detect CONDITION and Mitigate CONDITION). If it is desired add the relevant procedures to the Visio files.

Modifying an Equipment Type
1) Modify the existing “Distillation Column.”
   a. Add a new component named “Bottoms” of type “Flow” in the “Distillation Column.”
   b. Add a new component named “Reflux” by duplicating the component “Bottoms” (or “Feed”).
   c. All the modes, conditions, attributes, mode transitions, and mode-condition tables are the same.
   d. In the parent mode-component mode table, do not the change the “Feed” relationships. For “Bottoms”, set the values as given in Table 6. Finally, for “Reflux”, set the values as given in
   e. Table 7.

TABLE 6
Component-parent mode table for Bottoms

| Component | |
|---|---|
| Parent Mode | Bottoms |
| Shut Down | Closed |
| Normal Operation | Open |
| Total Reflux | Open |

TABLE 7
Component-parent mode table for Reflux

| Component | |
|---|---|
| Parent Mode | Reflux |
| Shut Down | Closed |
| Normal Operation | Open |
| Total Reflux | Open |

f. Commit the changes to the database. There should not be any issues.

Create an Equipment Item that Inherits From an Equipment Type
1) Create a new equipment item named “Feed Flow” that inherits from the Equipment Type “Flow.”
   a. Go to “Create Equipment Item” form, create an equipment item named “Feed Flow”, inherits from equipment type “Flow.”
   b. Set the pressure to be 10 [units are not known!], the temperature to 150 [degrees unknown], the location to be “University of Alberta.” The material type should be set to be water/steam. The maximum flow for the feed flow is 50.
   c. Add “Ammonia Composition”. “Water Composition”, and “Carbon Dioxide Composition” in the attribute table. For the “Value” column, enter the following values 0.1, 0.95, and 0.05 respectively for the relevant attributes.
   d. No further changes should be done. Commit the changes to the database.

Creating a New Composite Equipment Item
1) Create a new Distillation Column named “HP Still”
   a. Under “New Equipment Item” category, create a new equipment item named “HP Still” from the equipment type “Distillation Column.”
   b. Set the column operation efficiency to 75%, the column height to 5.2 m, the column type to “packed column.”
   c. Set the location to be the “University of Alberta.” Click on “Next.”
   d. In the Excel spreadsheet that appears, “HP Still” will be displayed in the column “New Equipment Item Name.” It is acceptable at this point to leave the name unchanged. Do not close the Excel spreadsheet.
   e. In the dialogue box that previously appeared, click the “Complete” button in the message window. This will automatically close the Excel spreadsheet and save in a location that the computer can easily retrieve again.
   f. Click on “Next” in all subsequent windows and commit the modifications to the database. Observe that the required Visio files are also created. Finally, verify that database and files are as per specifications.

Modifying an Existing Composite Equipment Item
1) Modify the existed “HP Still”
   a. In the attribute list, add “Distillate composition” and “Bottom composition” to the attribute list of the HP Still column. The value for the added “Distillate composition” is 75% while the “Bottom composition” is 0.001%.
   b. Nothing else should be changed.
   c. Commit the modifications to the database and create the Visio file, verify that the Visio files match the specifications.

Modifying an Equipment Item by Adding a Component
1) Set “Feed Flow” as the component item of “HP Still”
   a. Select “Modify Equipment Item”, choose “HP Still” from the drop down menu.
   b. Add “Feed Flow” as the component of “HP Still.” In the Excel spreadsheet that appears, the words “Feed Flow” will be displayed in the column “New Equipment Item Name.” It is acceptable at this point to leave the name unchanged. Do not close the Excel spreadsheet
   c. In the dialogue box that previously appeared, click the “Complete” button in the message window. This will automatically close the Excel spreadsheet and save in a location that the computer can easily retrieve again.
   d. Click on “Next” in all subsequent windows and commit the modifications to the database. Check the validity of the generated Visio files.

Startups, shutdowns and mode changes are the most dangerous times.

Operating Incidents happen when procedures are not followed.

BP Texas City CSB final report:
During the startup, operations personnel pumped flammable liquid hydrocarbons into the tower for over three hours without any liquid being removed, which was contrary to startup procedure instructions.

Why are these actions not automated?

The barrier is not technological; it is cognitive.

It is also the most interesting field in control today.

Operating Incidents happen when procedures are not followed.
75% of incidents at one site are caused by either “procedure not followed” or “inadequate procedure”.
Of incidents involving significant loss, ALL incidents are either caused by these, or are made much worse by not following procedures.

Startups, shutdowns and mode changes are the most dangerous times.
Under time pressure, people are more likely to make mistakes

Reduce operating risk during startups, shutdowns and operating mode changes.
Have procedures that are complete, detailed and up to date.
Automate where appropriate. Assist where possible

The barrier is not technological; it is cognitive.
Modern control systems can automate any defined set of panel operator actions.
We just can't define procedures with enough detail to automate them.

Three configurations have been developed
UltraLite SAGD Plant (Portable Exploration Model):
   Capacity (1,200 bpd) with production from 1-2 well pairs
   Fully functional and economic at smaller scale
   Well suited as pilot scale—portable for fast, efficient redeployment to a number of sites
1ⁿ Site_{TM} SAGD Plant (Commercial Production Model):
   Capacity (7,200 bpd) matched to full well pad production
   Portable enables relocation when resource exploited (efficient use of equipment and minimal abandonment and reclamation costs)
MultiSite SAGD Plant (Multiple Well Pad Facility):
   Capacity (20,000 bpd) with production from 2-4 well pads
   Capture economies of scale but maintains portability

Challenges:
Many plants with very similar topologies,
Small, centralized engineering group,
Almost no online surge capacity

Requirements:
Safe, efficient, reliable operation
Consistent controls across all plants,
Consistent operating procedures,
Automated operating procedures: hybrid system control.

3. Operating Procedure Lifecycle
Inefficient and slow
Large documents
Long delays in review and approval
Hard to share across plants
Hard to find every relevant procedure following an incident
Save time by restricting level of detail—assuming operator knowledge

Need to find a way to reduce the amount of work required to write and update procedures
Procedures are programs executed by people.
Use the methods of object-oriented software design and management to write and manage operating procedures, as well as to automate them.

4. A Better Way:

Object-Oriented Procedures
Procedures are programs executed by people.
Use the methods of object-oriented software design and management to write and manage operating procedures, as well as to automate them.

Refer to FIGS. 1A and 1B illustrating a Composition of a Plant (S88), these Figures show decomposition of a plant into several smaller Process Units: Inlet cooling and separation, Produced water deoiling, Produced water tank, BFW Tank, Boiler and Evaporator to name a few.

Procedures for the big object (plant) can be defined in terms of the simpler objects (units) that make it up, or compose it.

The higher level object (plant) does not need to know the details of the lower level object (unit).

This diagram highlights the major pieces of equipment, concentrating on the main process streams only. It is colour coded (red for oil, green for gas and blue for water).

Composition of a Unit see FIG. 2: illustrating evaporator unit further divided into modules: Feed, Distillate, tower, Compressor, Blow down.

Procedures for the big object (unit) can be defined in terms of the simpler objects (equipment modules) that compose it. See FIGS. 3A and B, each equipment module can be divided further into smaller modules: Vessel, Pump, valves and heat exchangers.

Each level in the hierarchy conceals its internal details from the level above it.

2. Object, Class and Inheritance

All pumps are pumps.
Centrifugal pumps are a type (or class) of pump.
All pumps have some things in common.
All centrifugal pumps have somewhat more in common.
There are sub-types of centrifugal pump (subclasses).

Procedures can be defined at the class level and used for all equipment of that class.
Written once, used many times

They can (and should) be written for the parent class when possible.
Further reuse of procedures

Equipment types can be defined at different levels—unit and sub-system as well as atomic. See FIG. 4.

Real plants have operating modes

Plant Level FIG. 5

Every box is a mode.

Every arrow is a procedure.

Modes are meaningful FIGS. 6-12
Different sets of governing differential/algebraic equations
Different impact on production
Different potential fault conditions, and hence different alarms
Operators have names for them

Subprocedures FIG. 13
High-level procedures are largely, if not completely, defined in terms of mode changes of components: subprocedures
Higher level procedures mostly refer to lower-level procedures, without knowing their internal details
Changes can be made at one level without affecting other levels.

Modes, conditions and procedures FIGS. 6-12
Modes and fault conditions define the procedures that are required
Plant hierarchy allows modes and procedures to be defined one level at a time
Lower-level modes/conditions affect higher-level modes/conditions
   “Causality flows up”
   There is not a one-to-one relationship between lower-level modes and higher-level modes.
Higher-level procedures affect lower-level modes
   Procedure actions mostly call for lower-level systems to change mode.
   “Commands flow down”

Unit and Equipment Module Modes: Different Configurations FIGS. 14A and 14B and 15

Unit modes are the same.

Modes of components are the same.

Low-level Equipment Module procedures are the same.

Only the arrangement is different—there are now 2 Towers

Minor changes, confined to the relevant level in the procedure—unit.

We can now manage procedures—define the hybrid control algorithms—for many plants.

The procedures have only minor differences, that are easy to find and manage.

Equipment hierarchy
Higher-level procedures refer to (“call”) lower-level procedures

Encapsulation
Higher-level equipment/procedures do not need to worry about lower-level details

Common low-level design patterns
Standard low-level procedures

Equipment (object) types
Define procedures at “type” level, not specific equipment item
Class hierarchy allows further re-use of procedures

Modes and Conditions
Determine the set of procedures we need
Direct tie-in to alarm management 5. Methodology
1. Define plant hierarchy FIG. 16A
2. Define class hierarchies FIG. 16B
3. Define state machines (modes and transitions) for object classes FIG. 16E
4. Write (or re-use existing) procedures for low-level object classes FIG. 13
5. Write procedures for higher-level classes in terms of mode changes of lower-level object classes (subprocedures) FIG. 16C
6. Class procedures are combined with specific equipment in plant hierarchy to produce actual, working procedures
7. Present procedures to the detail requested by the operator
8. Following an incident, revise (and review) only the part that needs it—for the class, not the instance. FIG. 16D

Manage procedures as software, not plain text documents.

Present procedures to operators specific to equipment, but write them as generic.

A content management system that facilitates this process has been built and is being used for Lewis Steepbank.

There remain many open questions, both theoretical and practical.
Interactions are not always hierarchical.
The law of leaky abstractions
The set of design patterns for low-level assemblies
flow to validate procedures
Relationship between modes and fault conditions
Automation directly from procedure
Effect of plant hierarchy on alarm management

As many changes can be made to the preferred embodiment of the invention without departing from the scope thereof; it is intended that all matter contained herein be considered illustrative of the invention and not in a limiting sense.

We claim:

1. A method for generating and maintaining procedures for plant operation the method comprising:
a. Decomposing a plant into process units;
b. Decomposing each process unit into equipment modules (high-level objects);
c. Decomposing equipment modules into equipment units (low-level objects);
d. Defining operational states for equipment modules and equipment units;
e. Generating a procedures for changing operational states for equipment units;
f. Generating a procedures for changing operational states for equipment modules;
g. Encapsulating all the equipment units procedures and equipment modules procedures into process unit operations preferably in a computer database;
h. Providing feedback for presentation of the operational procedures and state changing operating procedures from the preferred database to an operator upon request;
i. Revising single equipment unit or equipment module operating procedure or state changing operating procedure upon request from the operator;
wherein, the method allows the operator to receive a detailed description of an operating procedure for change of state of any process unit, equipment unit or equipment module in the plant from any state to any state.

2. The method of claim 1 wherein the same operating procedure for an equipment module can be reused for another equipment module.

3. The method of claim 1 wherein the same state changing operating procedure for an equipment unit can be reused for another equipment unit.

4. The method of claim 1 wherein one operating procedure may be used in several instances for operation of several equipment modules, while upon revising this procedure, it will be automatically revised for all the instances in all the processes, thus reducing the need to edit numerous instances of operational procedures.

5. The method of claim 1 wherein one state changing operating procedure may be used in several instances for operation of several equipment units, while upon revising this procedure, it will be automatically revised for all the instances in all the processes, thus reducing the need to edit numerous instances of operational procedures.

6. A method of generating and maintaining procedures for plant operation using a method of claim 4 or 5, wherein the procedure can be adapted to be used in another plant with a similar set of plant units without rewriting the whole operational procedure.

7. A method of generating and maintaining procedures for plant operation using a method of claim 4 or 5, wherein the procedure can be adapted to be used in another plant with a different set of plant units without rewriting the whole operational procedure.

8. A method for providing SAGD plant operation procedures, the method comprising:
a. Decomposing an SAGD plant into process units such as: water de-oiling unit, evaporator unit, inlet cooling and separation unit etc.;
b. Decomposing each process unit for example evaporator unit into equipment modules such as: feed module, distillate tank, evaporating tower, compressor, etc.;
c. Decomposing equipment modules for example compressor into equipment units such as first centrifugal pump, second centrifugal pump, suction drum, motor etc.;
d. Defining operational states for equipment modules and equipment units for example: shut down, normal operation, recycling mode, heating mode, cooling mode, bypass etc.;
e. Generating a procedure for changing operational state for equipment units for example: in order to change state of evaporator tower from normal to internal recycling operation, a specific set of steps has to be followed;
f. Generating a procedure for changing operational state for equipment modules for example: in order to change centrifugal pump from full off to normal operation a specific set of steps has to be followed;
g. Encapsulating all the equipment unit procedures and equipment module procedures into process unit operations preferably in a computer database for example: in order to operate an evaporator unit the following modules has to be initiated: feed module, tower module, compressor module and distillate module while each module in turn has the sets of operation for each of its corresponding units incorporated as well;
h. Providing feedback for presentation of the operational procedures and state changing operating procedures from the preferred database to an operator upon request for example: if the operator wishes to switch the evaporator from normal operation to internal recycle, the system will provide a detailed set of steps and the instructions of how to follow those steps;
i. Revising single equipment unit or equipment module operating procedure or state changing operating procedure upon request from the operator, if during the operation it was found that one of the instructions should be corrected, the correction can be made in the procedure of a specific equipment module or unit;
wherein, the method allows the operator to receive a detailed description of an operating procedure for change of state of any process unit, equipment unit or equipment module in the plant from any state to any state.

9. The method of claim 8 wherein the same operating procedure for an equipment module can be reused for another equipment module.

10. The method of claim 8 wherein the same state changing operating procedure for an equipment unit can be reused for another equipment unit.

11. The method of claim 8 wherein one operating procedure may be used in several instances for operation of several equipment modules, while upon revising this procedure, it will be automatically revised for all the instances in all the processes, thus reducing the need to edit numerous instances of operational procedures.

12. The method of claim 8 wherein one state changing operating procedure may be used in several instances for operation of several equipment units, while upon revising this procedure, it will be automatically revised for all the instances in all the processes, thus reducing the need to edit numerous instances of operational procedures.

13. A method of generating and maintaining procedures for plant operation using a method of claim 11 or 12, wherein the procedure can be adapted to be used in another plant with similar set of plant units without rewriting the whole operational procedure.

14. A method of generating and maintaining procedures for plant operation using a method of claim 11 or 12, wherein the procedure can be adapted to be used in another plant with different set of plant units without rewriting the whole operational procedure.
